(19) United States
(12) Patent Application Publication
(10) Pub. No.: US 2013/0290422 A1
(43) Pub. Date: Oct. 31, 2013

(54) CONFERENCE SUPPORT SYSTEM, CONFERENCE SUPPORT APPARATUS, AND HANDOUT DISTRIBUTION METHOD

(71) Applicants: Masateru KUMAGAI, Kanagawa (JP); Kei Oyamada, Kanagawa (JP)

(72) Inventors: Masateru KUMAGAI, Kanagawa (JP); Kei Oyamada, Kanagawa (JP)

(73) Assignee: RICOH COMPANY, LTD., Tokyo (JP)

(21) Appl. No.: 13/868,209

(22) Filed: Apr. 23, 2013

(30) Foreign Application Priority Data
Apr. 25, 2012 (JP) 2012-100289

(51) Int. Cl. H04L 29/06

(52) U.S. Cl. CPC H04L 65/403
USPC 709/204

(57) ABSTRACT

A conference support apparatus includes a first reception unit that receives position data from a position data transmission apparatus, an entire region determination unit that determines an entire region based on the position data, a transmission unit that transmits data of the entire region to a first terminal, a second reception unit that receives division data from the first terminal, a division unit that divides the entire region into a plurality of divisional regions, a third reception unit that receives terminal position data from a second terminal, a region determination unit that determines a target divisional region to which the second terminal belongs from the plurality of divisional regions based on the terminal position data, and a distribution unit that distributes handout data associated to the target divisional region to the second terminal.

### BACKGROUND OF THE INVENTION

1. Field of the Invention

The present invention relates to conference support systems, conference support apparatuses, and handout distribution methods.

2. Description of the Related Art

Typically, in a case of, for example, a conference where a presenter gives a presentation to participants of the conference, the presenter prepares presentation handouts for allowing the participants to easily understand the content of the presentation. At the conference, the presenter distributes the presentation handouts to the participants or transmits/displays the presentation handouts on the terminals of the participants. Particularly, in recent years, presentation handouts are often distributed in the form of digital data to the participants' terminals owing to the widespread use of terminals.

In some presentations, different types of presentation handouts may be distributed depending on the participant. For example, in a case of a public conference where the participants are divided into discussants and observers, the presentation handouts distributed to the discussants and observers may be different. As another example, in a case of an inside (inhouse) conference, the presentation handouts distributed to executives and regular employees may be different. Further, in a case of an outside conference, the presentation handouts distributed to guests and employees may be different. Further, in a case of an international conference, the presentation documents may be distributed in different languages in correspondence with the participants from various countries.

There are known technologies in which presentation handouts are set beforehand, on the conference system side (presentation system side), in correspondence with the participants of the conference after the participants of the conference have been registered, so that different presentation handouts can be distributed to each of the participants.

For example, Japanese Laid-Open Patent Publication No. 2005-284344 discloses a data process system for allowing participants in a conference system to easily share handouts. The data processing system includes a handout storage device, a handout set setting unit for setting one or more types of handout sets, a distribution setting unit for setting one or more sets of handouts (handout sets) to be distributed to the participants, and a transmitting unit for distributing the handout sets.

However, with the conventional conference system, in order to distribute different presentation handouts in correspondence with the participants of the conference system, the participants of the conference system are to be registered beforehand, and a corresponding relationship between the participants and the handout sets is required to be set. This process of registering the participants and setting the corresponding relationship is burdensome. Further, participants for whom a corresponding relationship has not yet been set (hereinafter also referred to as “unregistered participants and the like”), such as unexpected guests are unable to obtain the distributed handouts. In a case where the unregistered participants and the like are categorized as “others”, it is possible for unregistered participants and the like to obtain the distributed handouts. However, the unregistered participants and the like are only able to obtain handouts prepared for the category “others”. Therefore, in a case where the unexpected participant is, for example, a guest of honor or an executive that is supposed to obtain a special handout, it is still difficult to distribute the special handout to such unexpected participant.

### SUMMARY OF THE INVENTION

The present invention provides a conference support system, a conference support apparatus, and a handout distribution method that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a conference support system, a conference support apparatus, and a handout distribution method particularly pointed out in the specification in such full, clear, concise, and exact terms as to enable a person having ordinary skill in the art to practice the invention.

To achieve these and other advantages, and in accordance with the purpose of the invention, as embodied and broadly described herein, an embodiment of the present invention provides a conference support apparatus includes a first reception unit that receives position data from a position data transmission apparatus, an entire region determination unit that determines an entire region based on the position data, a transmission unit that transmits data of the entire region to a first terminal, a second reception unit that receives division data from the first terminal, a division unit that divides the entire region into plural divisional regions, a third reception unit that receives terminal position data from a second terminal, a region determination unit that determines a target divisional region to which the second terminal belongs from the plural divisional regions based on the terminal position data, and a distribution unit that distributes handout data associated to the target divisional region to the second terminal.

Other objects, features and advantages of the present invention will become more apparent from the following detailed description when read in conjunction with the accompanying drawings.

### BRIEF DESCRIPTION OF THE DRAWINGS

FIG. 1 is a schematic diagram of a network of a conference support system according to an embodiment of the present invention;

FIG. 2 is a schematic diagram illustrating a hardware configuration including main components of a conference support server according to an embodiment of the present invention;

FIG. 3 is a block diagram illustrating functions (functional components) of a setting terminal, a position data transmission apparatus, a display terminal, and a conference support server included in a conference support system according to an embodiment of the present invention;

FIG. 4 is a schematic diagram illustrating an example of determining entire region data according to an embodiment of the present invention;

FIG. 5 is a schematic diagram illustrating an example of a configuration of entire region data according to an embodiment of the present invention;

FIG. 6 is a schematic diagram illustrating another example (modified example) of determining entire region data according to an embodiment of the present invention;

FIG. 7 is a schematic diagram illustrating an example of obtaining divisional region data according to an embodiment of the present invention;

FIG. 8 is a schematic diagram illustrating an example of a configuration of divisional region data according to an embodiment of the present invention;

FIG. 9 is a schematic diagram illustrating an example of associating presentation handout data according to an embodiment of the present invention;

FIG. 10 is a sequence diagram for describing a region division step according to an embodiment of the present invention;

FIG. 11 is a schematic diagram for describing an example of a region division operation according to an embodiment of the present invention;

FIG. 12 is a schematic diagram illustrating an association operation (part 1) according to an embodiment of the present invention;

FIG. 13 is a schematic diagram illustrating the association operation (part 2) according to an embodiment of the present invention;

FIG. 14 is a sequence diagram for describing a handout data distribution step according to an embodiment of the present invention;

FIG. 15 is a schematic diagram illustrating an example of positions of seats of participants of a conference according to an embodiment of the present invention;

FIGS. 16A and 16B are schematic diagrams illustrating examples of display screens of display terminals according to an embodiment of the present invention;

FIG. 17 is an example of determining an entire region data according to modified example 1;

FIG. 18 is an example of an entire region data according to the modified example 1;

FIG. 19 is schematic diagram illustrating a modified example 2 of dividing an entire region into a plurality of divisional regions (Part 1);

FIG. 20 is a schematic diagram illustrating an example of associating a divisional region data 11b and a presentation handout data according to the modified example 2;

FIG. 21 is a schematic diagram illustrating the modified example 2 of dividing an entire region into plural divisional regions (Part 2);

FIG. 22 is a schematic diagram illustrating an example of associating a divisional region data and a presentation handout data according to the modified example 2;

FIG. 23 is a schematic diagram illustrating the modified example 2 of dividing an entire region into plural divisional regions (Part 3);

FIG. 24 is a schematic diagram illustrating an example of associating a divisional region data and a presentation handout data according to the modified example 2; and

FIG. 25 is a schematic diagram illustrating the modified example 2 of dividing an entire region into plural divisional regions (Part 4).

### DETAILED DESCRIPTION OF THE PREFERRED EMBODIMENTS

Next, embodiments of the present invention are described with reference to the attached drawings. In the following, the present invention is applied to the below-described embodiment of a conference support system (also referred to as “presentation system”).

### [Overview]

In a case of distributing different types of presentation handouts in correspondence with participants according to a conference support system of a related art example, the conference support system registers the participants together with corresponding profiles and allocates the presentation handouts to be distributed in correspondence with the profiles of the participants.

On the other hand, an embodiment of the present invention focuses on the locations (positions) in which the participants are seated. In order to sort and distribute the presentation handouts, the profiles of the participants are different in terms of, for example, the participant's position, role, or status. If there is no difference in the profiles of the participants, a uniform presentation handout need only be distributed. Therefore, in a case of a conference, there is a tendency of allocating the locations (positions) in which the participants are to be seated in correspondence with the profiles of the participants. In particular, this tendency occurs in large conferences in which the organizer (host) of the conference is required to smoothly organize the conference. For example, the organizer of the conference may sort and allocate the location (position) of the seats of the participants in correspondence with the participant's profile or the like (e.g., guest seats and regular seats).

With the below-described embodiments of the present invention, a venue of a presentation is divided into plural areas (regions) in correspondence with the location in which participants are to be seated, and the type of presentation handouts to be distributed to the terminals of the participants in each of the plural areas is determined. In other words, according to the below-described embodiments of the present invention, a conference support system obtains position data from the terminals of the participants at a timing in which the participants are seated and determines the presentation handouts to be distributed upon confirming the areas in which the participants are seated.

Therefore, with the below-described embodiments of the present invention, the process of registering the participant beforehand or the process of setting a corresponding relationship between the participants and the handout sets can be omitted. Therefore, even in a case where an unexpected person (e.g., unexpected guest) participates in the conference and is seated at the conference, an appropriate presentation handout can be distributed to the unexpected person.

### [System Configuration]

### (Network Configuration)

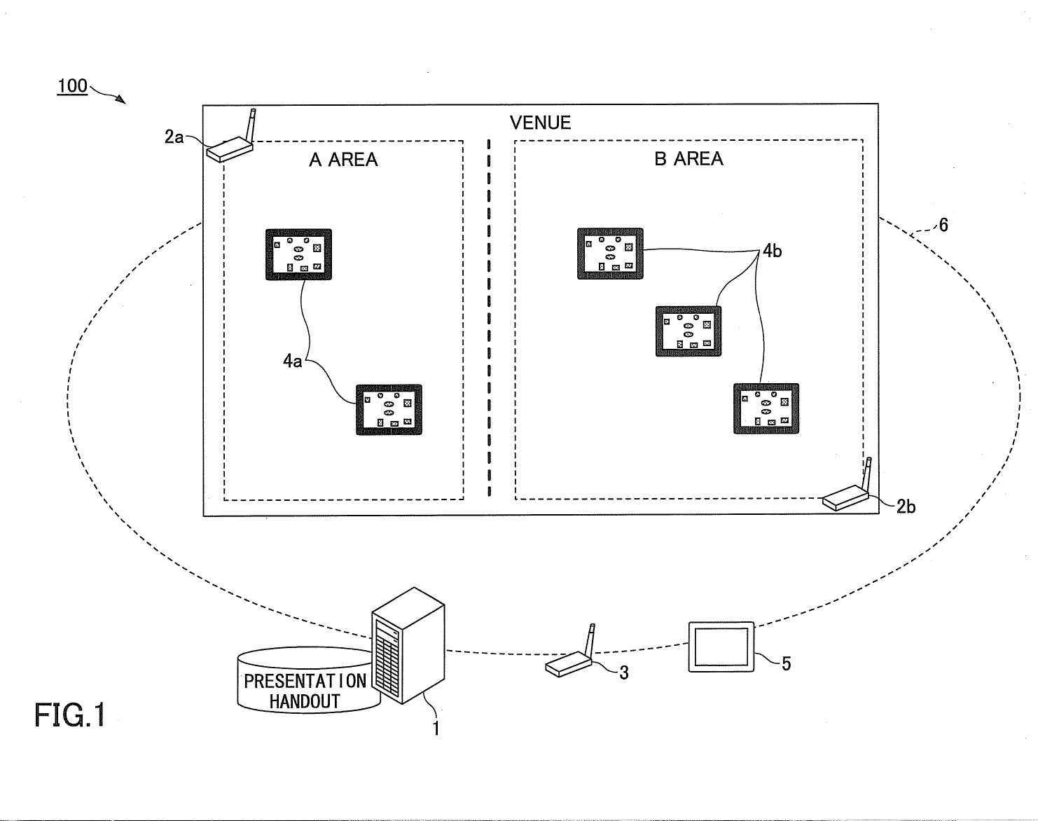

FIG. 1 is a schematic diagram of a network of a conference support system 100 according to an embodiment of the present invention. The conference support system 100 includes a conference support server 1, a position data transmission apparatus 2, a position data reception apparatus 3, a display terminal(s) 4, and a setting terminal 5, which are connected via a network 6.

The conference support server 1 is a server that distributes presentation handouts to one or more display terminals 4 located in, for example, a venue of a conference. The timing of distributing the presentation handouts is concurrent with or after the participant carrying the display terminal 4 takes a seat at the venue. In a case where the display terminal 4 is placed at each seat beforehand, the presentation handouts are distributed on or after the display terminal 4 is placed at each seat. Further, the presentation handouts may be distributed a single time (i.e. in a batch) before the starting of, for example, a presentation. Alternatively, the presentation handouts may be distributed page by page (i.e. in slide style) in correspondence with the proceeding of the presentation. The method for distributing the presentation handouts is described in detail below.

Two or more position data transmission apparatuses 2 may be placed in the venue, so that the position data transmission apparatuses 2 can be used to obtain position data of the entire venue. For example, the organizer of the conference may place the position data transmission apparatuses 2 prior to the start of the conference for obtaining the position data of the entire venue. Each of the position data transmission apparatuses 2 transmits position data of the position data transmission apparatus itself 2 to the position data reception apparatus 3. The conference support server 1 receives the position data from plural position data transmission apparatuses 2 via the position data reception apparatus 3 to grasp (obtain) the position data of the entire venue of the conference based on the received position data.

The position data reception apparatus 3 receives the position data of the position data transmission apparatuses 2 and the position data of the display terminals 4. The position data received from the position data transmission apparatuses 2 and the display terminals 4 may be, for example, coordinate data. Then, the position data reception apparatus 3 transfers the received position data to the conference support server 1. It is to be noted that the position data reception apparatus 3 may be directly connected to the conference support server 1. In a case where the position data reception apparatus 3 is directly connected to the conference support server 1, the conference support server 1 also serves as the position data reception apparatus 3. Further, unlike the position data transmission apparatus 2, the position data reception apparatus 3 does not necessarily need to be placed within the bounds of the venue.

The display terminal is a computer terminal that enables a participant to browse a presentation handout (handout browsing computer terminal). After the participant is seated, the display terminal 4 transmits the position data (e.g., coordinate data) of the display terminal 4 itself to the position data reception apparatus 3. After transmitting the position data, the display terminal 4 receives a data of a presentation handout (presentation handout data) from the conference support server 1. It is to be noted that the display terminal 4 may be a terminal that is owned by the participant or a terminal prepared by the organizer of the conference. In a case where the display terminal 4 is a terminal prepared by the organizer of the conference, the display terminal 4 is placed beforehand at the seat of the participant. In this embodiment, the display terminal 4 is a terminal owned and brought by the participant.

The setting terminal 5 is a computer terminal that is used for enabling the organizer to set the details for dividing an entire region of the venue into plural regions. For facilitating the operation of setting the details for dividing the entire region of the venue, the setting terminal 5 may be a tablet type terminal that allows the organizer to operate by touching a display screen of the setting terminal 5. The use of the setting terminal 5 is described in detail below.

The network 6 is a communication network for both wired and wireless communications. From the aspect of wiring arrangement, wireless communications are preferred to be used for the communications between the position data transmission apparatus 2 and the position data reception apparatus 3 (e.g., by way of a wireless LAN (Local Area Network)). For the same reason, wireless communication is also preferable for the communications between the conference support server 1 and the display terminal 4.

### (Hardware Configuration)

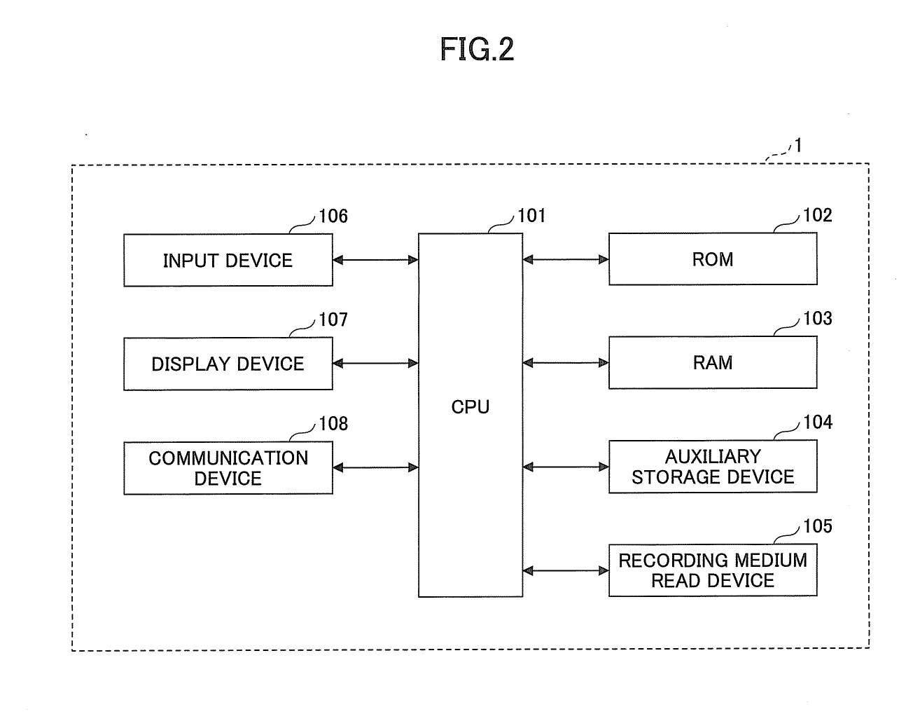

Next, a hardware configuration of the conference support server 1 according to an embodiment of the present invention is described. FIG. 2 is a schematic diagram illustrating the hardware configuration including the main components of the conference support server 1 according to an embodiment of the present invention. The conference support server 1 mainly includes, for example, a CPU (Central Processing Unit) 101, a ROM (Read Only Memory) 102, a RAM (Random Access Memory) 103, an auxiliary storage device 104, a recording medium read device 105, an input device 106, a display device 107, and a communication device 108.

The CPU 101, which includes a microprocessor and peripheral circuits surrounding the microprocessor, controls the entire conference support server 1. The ROM 102 is a memory that stores predetermined control programs (software components) to be executed by the CPU 101. The RAM is a memory used as a work area (work space) when the CPU 101 implements various controls by executing the predetermined control programs (software components) stored in the ROM 102.

The auxiliary storage device 104 is a device that stores various data including a general purpose OS (Operating System) and various program. The auxiliary storage device 104 may be, for example, a non-volatile storage device such as a HDD (Hard Disk Drive).

The input device 106 is a device that enables the user to perform various input operations. The input device 106 may be, for example, a mouse, a keyboard, and/or a touch panel switch provided on a display screen of the display device 107 in a superposing manner. The display device 107 is a device that displays various data on the display screen thereof. For example, the display device may include, for example, a LCD (Liquid Crystal Display) or a CRT (Cathode Ray Tube).

The communication device 108 is a device that performs communications with other devices via the network 60. The communication device 108 supports communications of the conference support server 1 in correspondence with the type of network used for communication (e.g., wired network, wireless network).

It is to be noted that each of the display terminal 4 and the setting terminal 5 includes at least a communication device for communicating with the conference support server 1 (e.g., wireless LAN card), a communication device for transmitting/receiving position data (e.g., antenna), and a display device. Further, each of the position data transmission apparatus 2 and the position data reception apparatus 3 includes a communication device for transmitting/receiving position data (e.g., antenna). In a case where the position data transmission apparatus 2 obtains position data of the position data transmission apparatus 2 itself or the display terminal 4 obtains position data of the display terminal 4 itself, the position data transmission apparatus 2 and the display terminal 4 may obtain the position data by using GPS (Global Positioning System). In this case, a reception apparatus for receiving GPS position data may be included in the position data transmission apparatus 2 or the display terminal 4.

### (Function)

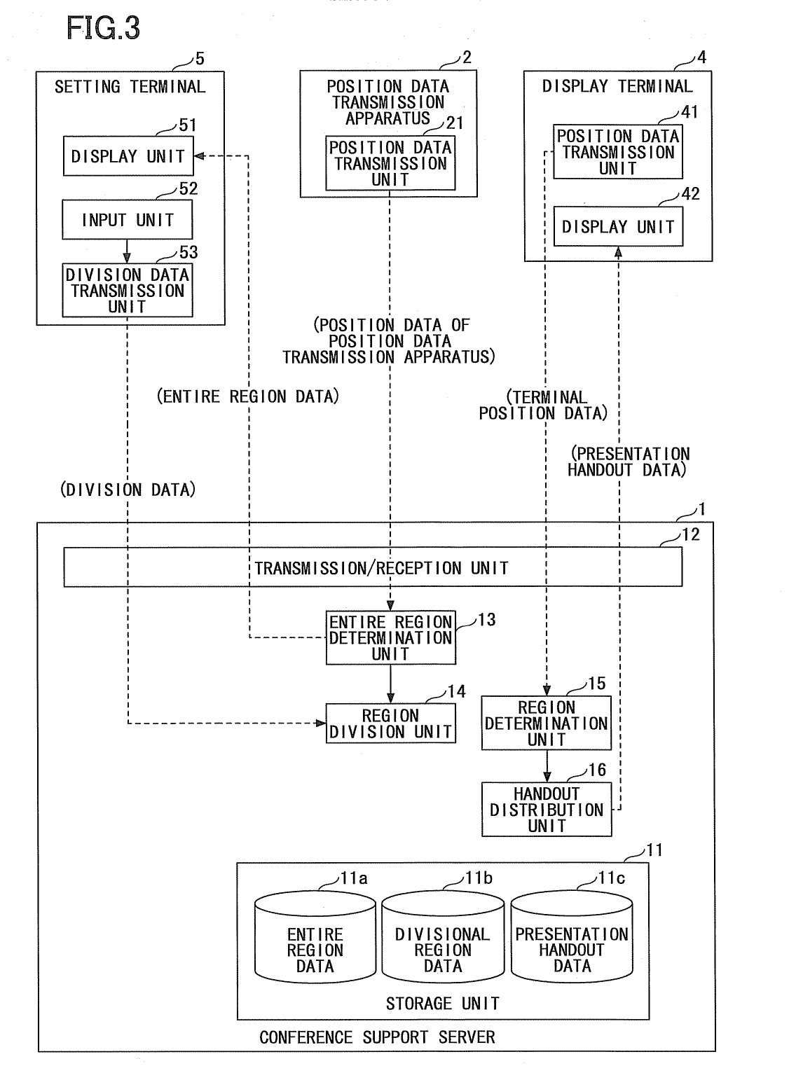

Next, a functional configuration of the conference support system 100 according to an embodiment of the present invention is described. FIG. 3 is a block diagram illustrating functions (functional components) of the setting terminal 5, the position data transmission apparatus 2, the display terminal 4, and the conference support server 1 included in the conference support system 100 according to an embodiment of the present invention.

As described above, the position data reception apparatus 3 receives position data (e.g., coordinate data) from each of the position data transmission apparatus 2 and the display terminal 4 and transfers the received position data to the conference support server 1. In other words, the position data reception apparatus 3 simply serves as a relay apparatus for relaying the received position data to the conference support server 1. Thus, for the sake of convenience, the position data reception apparatus 3 is omitted in FIG. 3.

### <Position Data Transmission Apparatus 2>

The position data transmission apparatus 2 includes a position data transmission unit 21. The position data transmission unit 21 transmits position data (e.g., coordinate data) of the position data transmission apparatus 2 itself to the conference support server 1 via the position data reception unit 3. Thereby, the conference support server 1 obtains (grasps) the position data of the entire venue based on the position data received from the position data transmission apparatus 2.

### <Setting Terminal 5>

The setting terminal 5 includes a display unit 51, an input unit 52, and a division data transmission unit 53.

The display unit 51 receives an entire region data indicating the entire region of the venue and displays the entire region of the venue. Thereby, the organizer can recognize the structure of the entire venue.

The input unit 52 accepts (receives) operations performed on the display screen of the setting terminal 5 and inputs division data (e.g., divisional line) for dividing the entire venue.

The division data transmission unit 53 transmits the input division data to the conference support server 1.

### <Display Terminal 4>

The display terminal 4 includes a position data transmission unit 41 and a display unit 42.

The position data transmission unit 41 transmits position data (e.g., coordinate data) of the display terminal 4 itself as terminal position data. Because the display terminal 4 is a terminal owned by the participant, the position data transmitted by the display terminal 4 also serves as position data of the participant.

The display unit 42 displays handout data distributed from the conference support server 1. Because the handout data corresponds to the presentation handout to be used in the conference, the participant participates to the conference by browsing the presentation handout.

### [Conference Support Server 1]

The conference support server 1 includes a storage unit 11, a transmission/reception unit 12, an entire region determination unit 13, a region division unit 14, a region determination unit 15, and a handout distribution unit 16.

The storage unit 11 stores entire region data 11a that indicate an entire region of the venue of the conference, a divisional region data 11b that indicates divisional regions obtained by dividing the entire region of the venue of the conference, and handout data 11c that are to be distributed to the display terminals 4 of the participants of the conference. Each of the entire region data 11a and the divisional region data 11b is generated with respect to each conference by the conference support system 100 and stored in the storage unit 11. The document data is generated and stored in the storage unit 11 by the organizer of the conference.

The transmission/reception unit 12 performs data transmission/reception with respect to external apparatuses outside the conference support server 1.

The entire region determination unit 13 determines the entire region of the venue based on the position data of the position data transmission apparatus 2. For example, in a case where the entire region of the venue has a rectangular shape, the entire region of the venue can be determined based on the position data obtained from at least two position data transmission apparatuses 2. Further, the entire region determined by the entire region determination unit 13 is stored as the entire region data 11a in the storage unit 11.

The region division unit 14 divides the entire region of the venue into plural divisional regions based on the division data received from the setting terminal 5. Accordingly, the entire region of the venue is segmented by a division line included in the division data, so that the entire region of the venue is divided into two or more divisional regions such as A area and B area. Further, the divisional regions of the entire region are stored as the divisional region data 11b in the storage unit 11.

The region determination unit 15 determines the divisional region to which the display terminal 4 belongs from the plural divisional regions divided by the region division unit 14 based on the terminal position data received from the display terminal 4. For example, the region determination unit 15 determines whether the display terminal 4 is positioned in the A area or the B area.

The handout distribution unit 16 obtains handout data 11c associated to the divisional region of the display terminal 4 determined by the region determination unit 15 and distributes the handout data 11c to the display terminal 4 belonging to the determined divisional region. For example, in a case where the display terminal 4 is positioned in the A area, the handout data 11c associated to the A area (handout data dedicated for the A area) is distributed to the display terminal 4. In a case where the display terminal 4 is positioned in the B area, the handout data 11c associated to the B area (handout data dedicated for the B area) is distributed to the display terminal 4. In other words, the handout data that is to be distributed differs depending on a positional area of the display terminal 4 in the venue.

Hence, the above-described functions performed by the functional components of the setting terminal 5, the position data transmission apparatus 2, the display terminal 4, and the conference support server 1 are actually implemented with a program executed by the CPU of a computer included in each of the setting terminal 5, the position data transmission apparatus 2, the display terminal 4, and the conference support server 1. Further, the above-described functional components are illustrative and may be provided in, for example, other external apparatuses or other servers. For example, the storage unit 11 of the conference support server 1 may be provided in another server such as a file server.

(Entire Region Data 11a)

Next, the entire region data 11a stored in the storage unit 11 of the conference support server 1 is described.

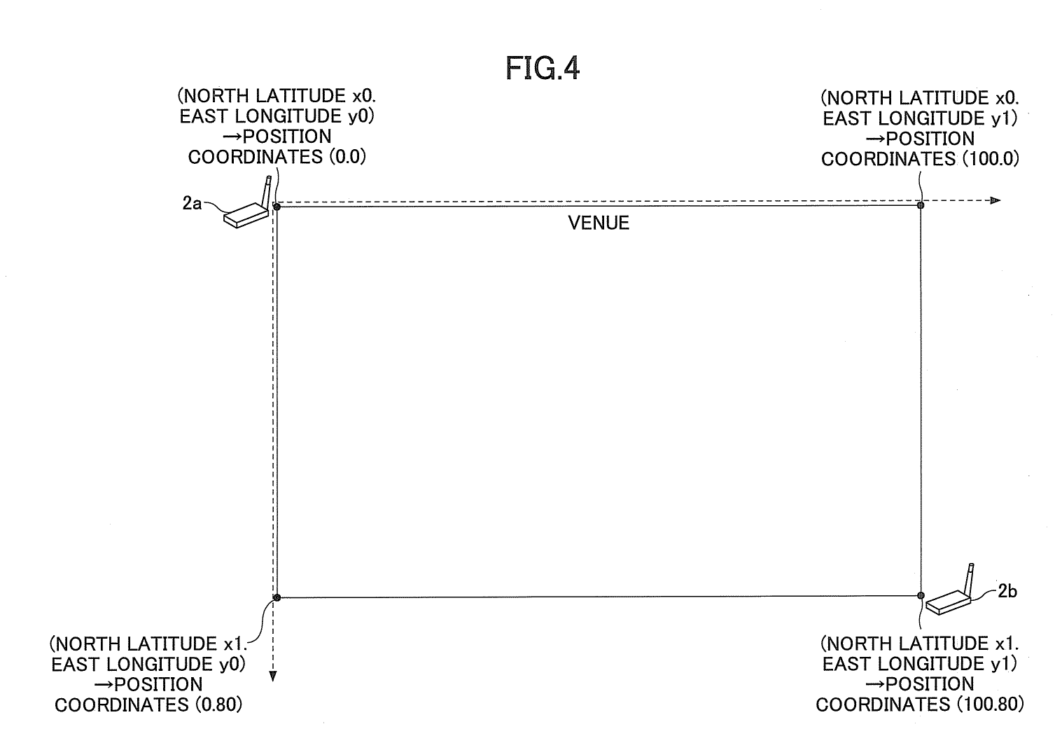

FIG. 4 is a schematic diagram illustrating an example of determining the entire region data 11a. As described above, the entire region data 11a indicates the entire region of the venue. The entire region data 11a is determined by the entire region determination unit 13 based on the position data of the position data transmission apparatus 2.

For example, in a case where the venue of the conference is shaped as a rectangle, the organizer of the conference places the position data transmission apparatuses 2a and 2b on a diagonal line of the rectangle. The two position data transmission apparatuses 2a and 2b obtain the position data of the position data transmission apparatus 2a, 2b themselves, respectively. Then, each of the position data transmission apparatuses 2a and 2b transmits the obtained position data to the conference support server 1.

In a case where the position data transmission apparatus 2 uses GPS data as position data, the position data apparatus 2 measures/obtains GPS position coordinates for each position data transmission apparatus 2 positioned at the corners of the rectangle of the venue. In this embodiment, positions coordinates of two points (north latitude x0. east longitude y0) and (north latitude x1. east longitude y1) are measured. The measured position coordinates are input to the conference support server 1.

The conference support server 1 determines the entire region of the venue based on the position coordinates of the input two points as illustrated in FIG. 4. In this embodiment, the conference support server 1 can determine the entire region of the venue based on the position data obtained from at least two position data transmission apparatuses 2 because the entire region of the venue has a rectangular shape. More specifically, in this embodiment, the conference support server 1 can determine that the region formed by the position coordinates of 4 points (north latitude x0. east longitude y0), (north latitude x0. east longitude y1), (north latitude x1. east longitude y0), and (north latitude x1. east longitude y1) corresponds to the entire region of the venue.

It is to be noted that the entire region is converted into virtual position coordinates as illustratively shown as follows.

(north latitude x0. east longitude y0)→(0.0)
(north latitude x0, east longitude y1)→(100.0)
(north latitude x1. east longitude y0)→(0.80)
(north latitude x1. east longitude y1)→(100.80)

The converted entire region is stored as entire region data 11a in the storage unit 11.

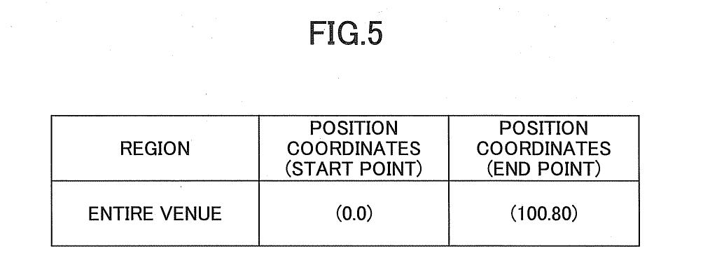

FIG. 5 is a schematic diagram illustrating an example of a configuration of the entire region data 11a. In this embodiment, the entire region data of the entire venue can be determined by storing the position coordinates of the start point and the end point because the venue has a rectangular shape.

It is to be noted that the above-described GPS position coordinates of the entire region is converted into virtual position coordinates merely for the sake of convenience. That is, the GPS position coordinates need not be converted into virtual position coordinates. Thus, the GPS position coordinates may be used as is. In the case where the GPS coordinates are not converted, the position coordinates of (start point) and (end point) are stored in the form of GPS position coordinates. For example, the position coordinates of (start point) may be stored as (north latitude x0. east longitude y0), and the position coordinates of (end point) may be stored as (north latitude x1. east longitude y1).

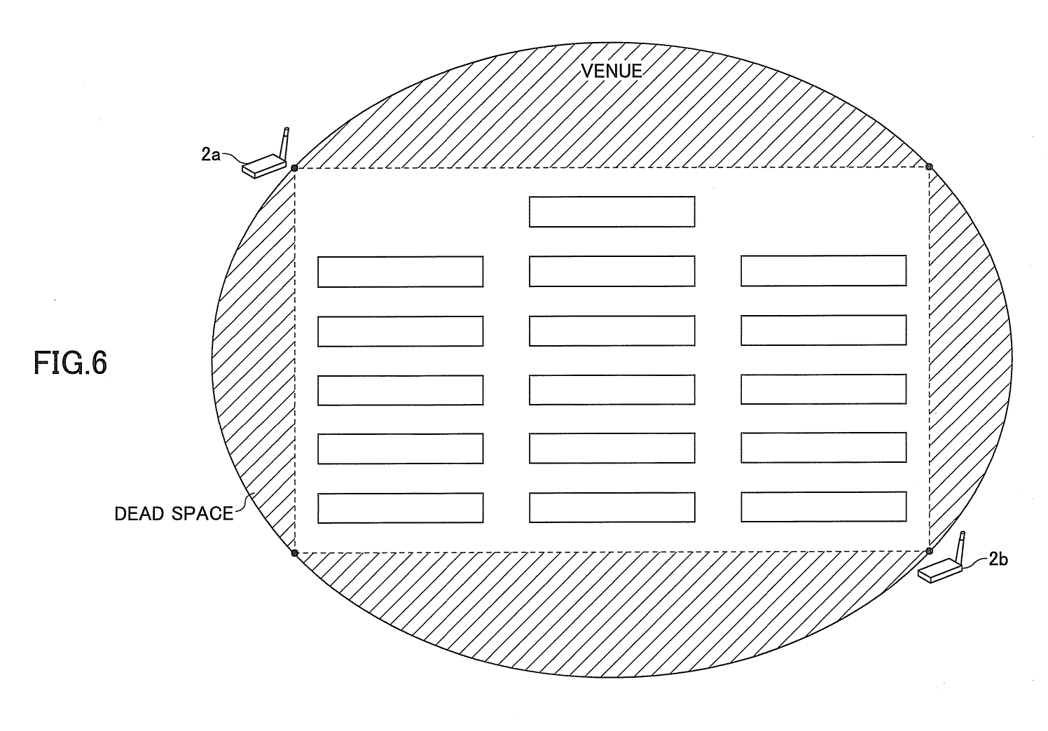

FIG. 6 is a schematic diagram illustrating a schematic diagram illustrating another example (modified example) of determining the entire region data 11a. In some cases, the shape of the venue is not always a rectangle. For example, in a case where the venue has a circular shape or an elliptical shape, the GPS position coordinates are measured/obtained from the points illustrated in FIG. 6. As long as entire region data that includes the seats of the participants in the venue, the venue may have a shape other than a rectangle.

(Divisional Region Data 11b)

Next, the divisional region data 11b stored in the storage unit 11 of the conference support server 1 is described.

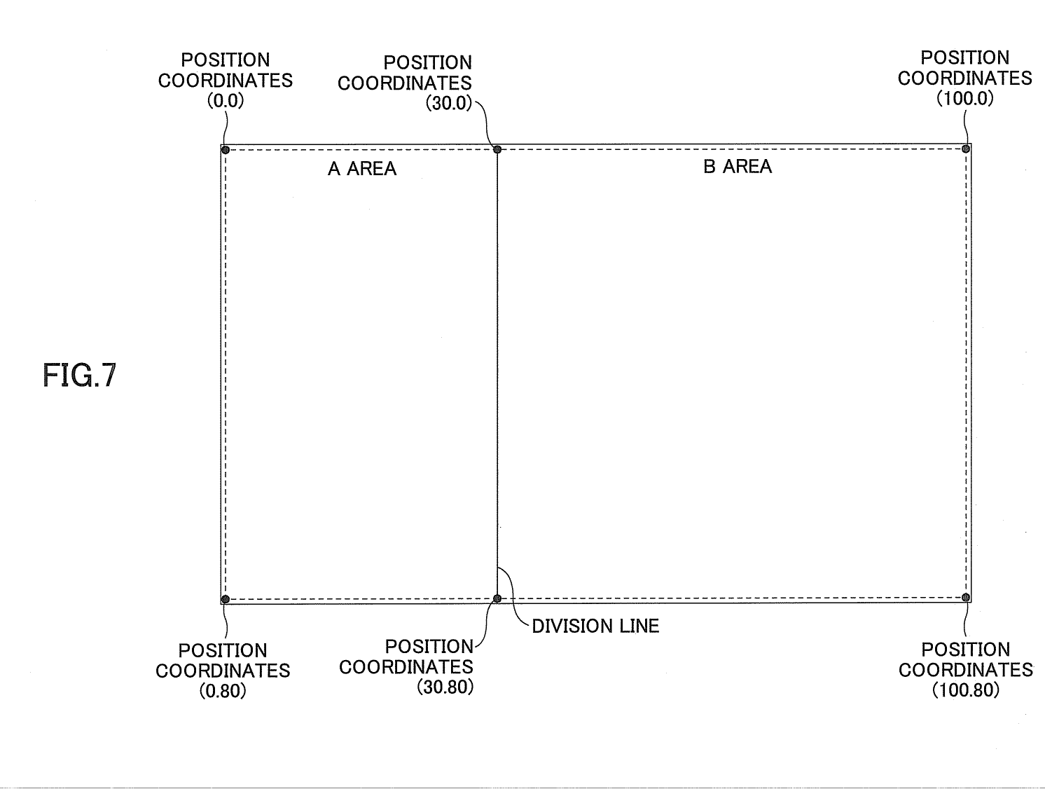

FIG. 7 is a schematic diagram illustrating an example of obtaining the divisional region data 11b. The divisional region data 11b is stored in the storage unit 11 in correspondence with each conference. In a case where the conference support server 1 receives division data (e.g., divisional line) from the setting terminal 5, the conference support server 1 divides the entire region of the venue into plural divisional regions based on the divisional line included in the division data. For example, as illustrated in FIG. 7, in a case where the GPS position coordinates of the division data (e.g., divisional line) is (north latitude x0.3. east longitude y0) and (north latitude x0.3. east longitude y0.8), the GPS position coordinates are converted into virtual position coordinates (30.0) and (30.80) in the manner described above. Then, the entire region of the venue is divided by a divisional line that passes through the position coordinates (30.0) and (30.80). In the example illustrated in FIG. 7, the divisional line is perpendicular to the long side of the rectangular shape of the venue, and the entire region of the venue is divided into an A area and a B area.

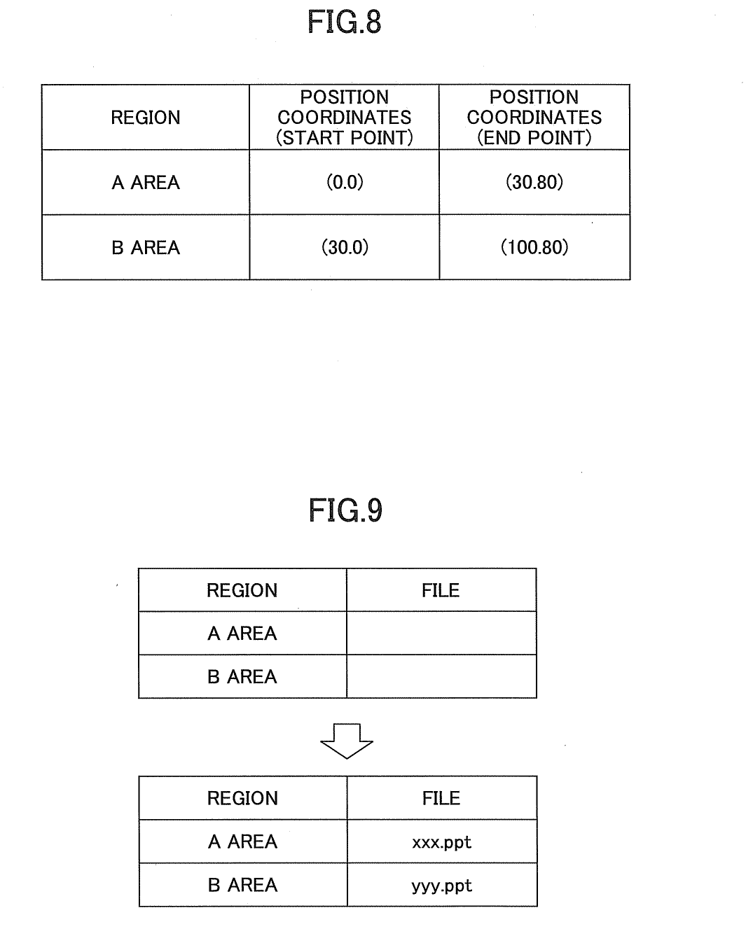

FIG. 8 is a schematic diagram illustrating an example of a configuration of the divisional region data 11b. In this embodiment, the position data of the divisional regions of the venue can be determined by storing the position coordinates of the start point and the end point because the venue has a rectangular shape. Because the entire region of the venue is divided into the A area and the B area, the position coordinates of the start and end points of each of the divisional area (A area, B area) are stored.

(Presentation Handout Data 11c)

Next, the presentation handout data 11c stored in the storage unit 11 of the conference support server 1 is described.

FIG. 9 is a schematic diagram illustrating an example of associating the presentation handout data 11c. The storage unit 11 stores data files of the presentation handout data 11c itself. Further, the storage unit 11 stores an association relationship between divisional regions and corresponding presentation handout data 11c. After the entire region of the venue is divided into divisional regions, the organizer can perform an operation of setting an association relationship in which the files of the presentation handout data 11c are associated with specific divisional regions. The association relationship set by the organizer is transmitted as association data from the setting terminal 5 to the conference support server 1. Thereby, the conference support server 1 stores the presentation handout data 11c in association with the divisional regions of the venue.

In this example, the entire region of the venue is divided into the A area and the B area. Accordingly, presentation handout data “xxx.ppt” is associated to the A area, and presentation handout data “yyy.ppt” is associated to the B area. Based on this association between the divisional areas and the presentation handout data, presentation handout data 11c associated with corresponding divisional areas are distributed to each area.

### [Data Processing]

Next, data processing by the conference support system 100 according to an embodiment of the present invention is described. The data processing can be divided into a region division step and a handout data distribution step. The region division step and the handout data distribution step are described separately.

### (Region Division Step)

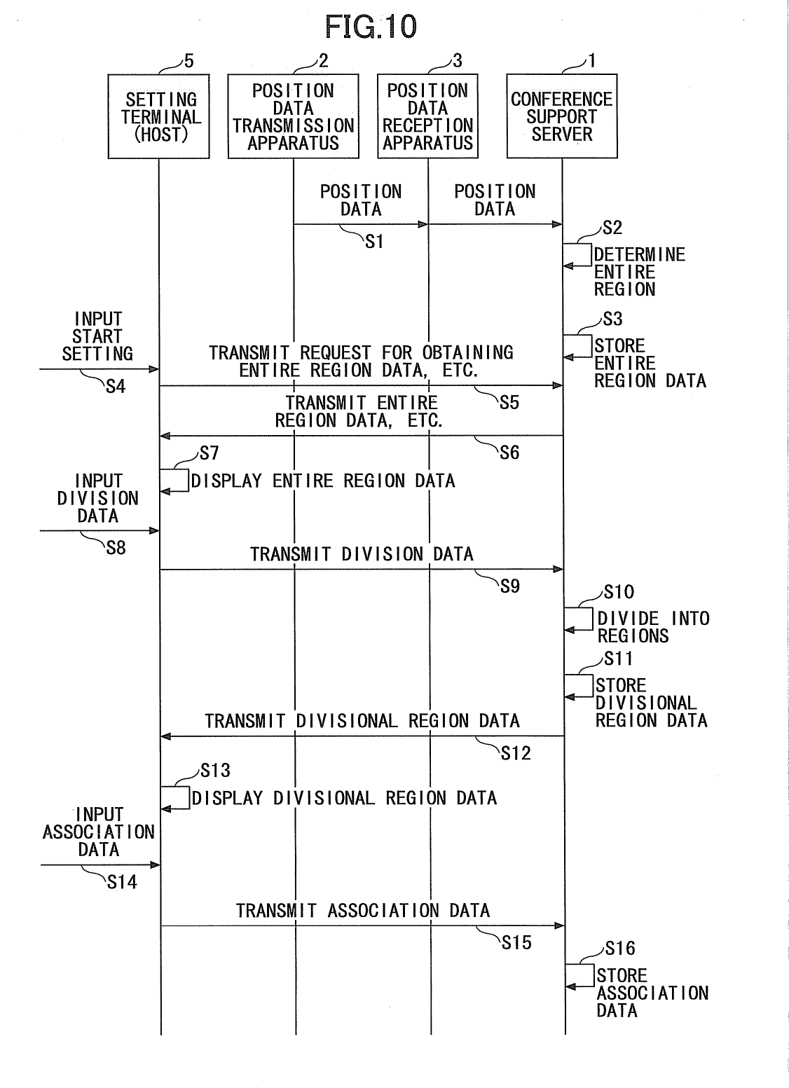

FIG. 10 is a sequence diagram for describing the region division step according to an embodiment of the present invention. The region division step is a preparatory stage for organizing a conference. Therefore, the region division step is performed before the participants of the conference are seated at the venue. As a premise, the position data transmission apparatuses 2 are already placed at the venue. Further, the presentation handout data 11c are already stored in the storage unit 11.

Step S1: The position data transmission unit 21 of the position data transmission apparatuses 2 transmit the position data (e.g., coordinate data) of the position data transmission apparatus 2 itself, respectively, to the position data reception apparatus 3. Then, the position data reception apparatus 3 transmits the received position data to the conference support server 1.
Step S2: When the conference support server 1 receives the position data from the position data reception apparatuses 2, the entire region determination unit 13 of the conference support server 1 determines the entire region of the venue based on the position data of the position data transmission apparatuses 2. For example, in a case where the shape of the entire region of the venue is a rectangle, the entire region of the venue is determined based on the position data transmitted from at least two position data transmission apparatuses 2.
Step S3: The entire region determination unit 13 stores the determined entire region as entire region data 11a in the storage unit 11 (see, for example, FIG. 5).
Step S4: Then, the organizer (host) of the conference performs a setting start operation to initiate a region division operation (region division setting) for dividing the entire region of the venue into plural divisional regions.
Step S5: When a start setting is input to the setting terminal 5 by the setting start operation of the organizer, the display unit 51 of the setting terminal 5 transmits a request for obtaining data such as data pertaining to the entire region of the venue (e.g., entire region data 11a, handout data) to the conference support server 1.
Step S6: In response to the request transmitted from the setting terminal 5, the entire region determination unit 13 transmits the requested data pertaining to the entire region (e.g., entire region data 11a, handout data) to the setting terminal 5.
Step S7: Upon receiving the data pertaining to the entire region (e.g., entire region data 11a, handout data) from the conference support server 1, the display unit 51 of the setting unit 5 displays the entire region of the venue on the display screen of the setting terminal 5 by using the entire region data 11a included in the received data.
Step S8: When the entire region of the venue is displayed on the display screen of the setting terminal 5, the organizer performs an operation of dividing the entire region of the venue into plural divisional regions by inputting division data, for example, by way of touching the display screen of the setting terminal 5.

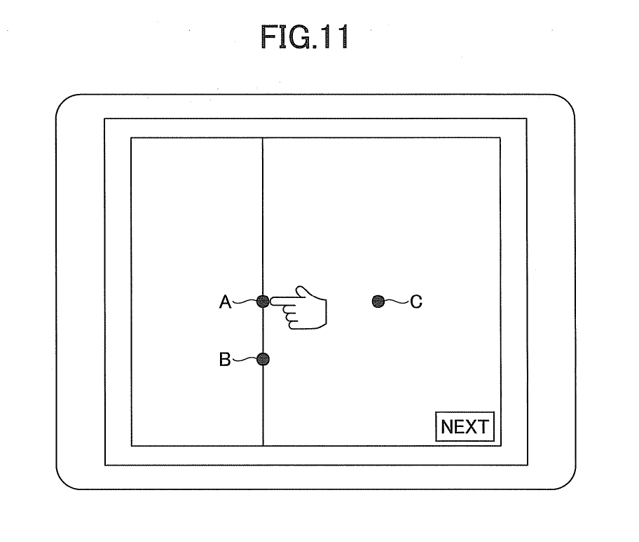

FIG. 11 is a schematic diagram for describing an example of the region division operation according to an embodiment of the present invention. In a state where the entire region of the venue is displayed on the display screen of the setting terminal 5, the organizer touches a desired point (e.g., point A) located in the entire region displayed on the display screen of the setting terminal 5. When the desired point is touched, a divisional line is automatically illustrated in the entire region displayed on the display screen of the setting terminal 5. Although the divisional line is illustrated as a vertical (perpendicular) line in the example of FIG. 11, the divisional line may be illustrated as a horizontal line in the entire region displayed on the display screen of the setting terminal 5. Alternatively, the organizer may perform the touch operation in a manner tracing desired consecutive points (e.g., point A, point B) in the entire region displayed on the display screen of the setting terminal 5. When the desired points (in FIG. 11, points A and B) are traced, a divisional line (in FIG. 11, vertical line) is automatically illustrated in the entire region displayed on the display screen of the setting terminal 5. Alternatively, in a case where the organizer may perform the touch operation in a manner tracing desired consecutive points (e.g., point A, point C) in the entire region displayed on the display screen of the setting terminal 5, a divisional line (in FIG. 11, horizontal line) is automatically illustrated in the entire region displayed on the display screen of the setting terminal 5 when the desired points (in FIG. 11, points A and C) are traced. After the position for dividing the entire region is determined by the illustration of the division line, the organizer presses the “NEXT” button displayed on the display screen of the setting terminal 5.

Step S9: When the “NEXT” button displayed on the display screen of the setting terminal 5 is pressed, the division data transmission unit 53 of the setting terminal 5 transmits division data to the conference support server 1. The division data may be any form of data that expresses the division line input by the organizer. For example, the division data may be expressed with virtual position coordinates of two arbitrary points located on the division line such as (30.0) and (30.80) (see, for example, FIG. 7). Alternatively, the division data may be expressed by, for example, a combination of virtual position coordinates (30.0) and data indicating “vertical”.
Step S10: The region division unit 14 of the conference support server 1 divides the entire region of the venue into plural divisional regions based on the division data received from the setting terminal 5 and the entire region data 11a. In this example, the received division data indicates a division line passing through the virtual position coordinates of (30.0) and (30.80). Accordingly, the entire region of the venue is divided by the division line indicated in the division data. In this example, the entire region of the venue is divided into the A area and the B area as illustrated in FIG. 7.
Step S11: The region division unit 14 stores the division results of Step S10 as divisional region data 11b in the storage unit 11. In this example, the divisional region data 11b is stored in a manner illustrated in FIG. 8 because the entire region of the venue is divided into the A area and the B area.
Step S12: In response to the division data transmitted from the setting terminal 5, the region division unit 14 transmits the divisional region data 11b along with data indicating that the entire region has been successfully divided to the setting terminal 5.
Step S13: When the setting terminal 5 receives the divisional region data 11b, the display unit 51 displays the regions determined as divisional regions of the entire region of the venue on the display screen of the setting terminal 5.
Step S14: After the entire region of the venue is divided, the organizer inputs data that associates the divisional regions with handout data to the setting terminal 5 by way of, for example, touching the display screen of the setting terminal 5.

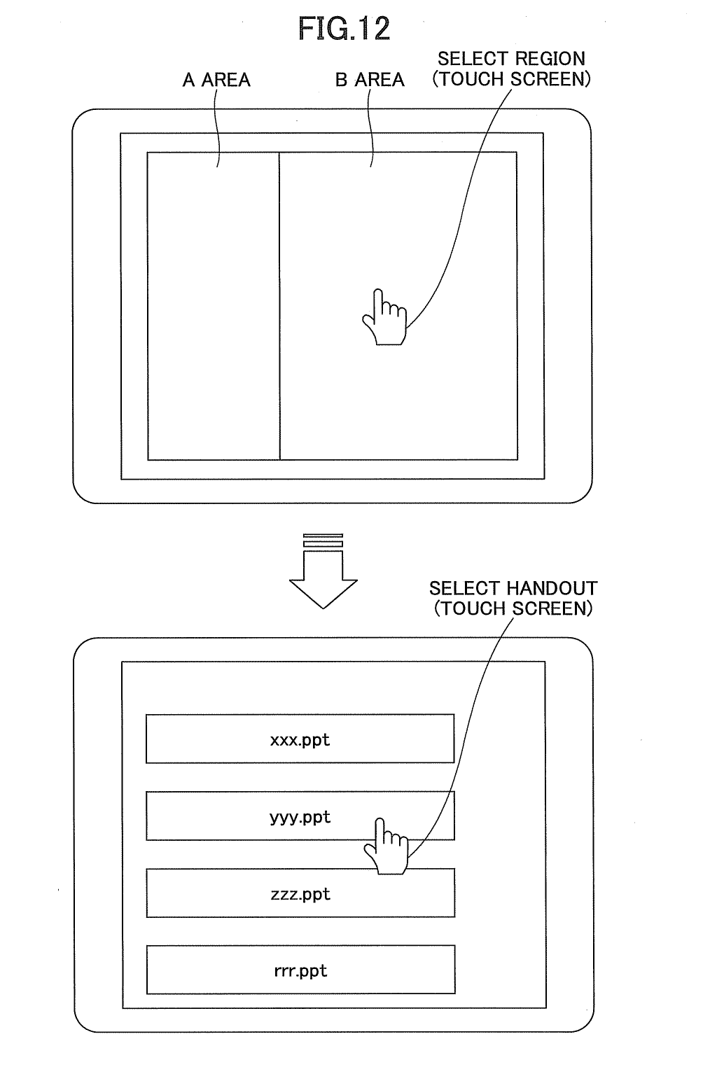

FIG. 12 is a schematic diagram illustrating an association operation (part 1) according to an embodiment of the present invention. The organizer touches one divisional region (e.g., B area) displayed on the display screen of the setting terminal 5. Then, a handout data list is displayed on the display screen of the setting screen 5. The handout data list is displayed based on the handout data (e.g., data file names of handout data) received in Step S6. The handout data listed in the handout data list corresponds to a handout data list stored in the storage unit 11.

The organizer selects handout data (e.g., “yyy.ppt”) desired to be associated to a single divisional region (e.g., B area) from the handout data list displayed on the display screen of the setting terminal 5.

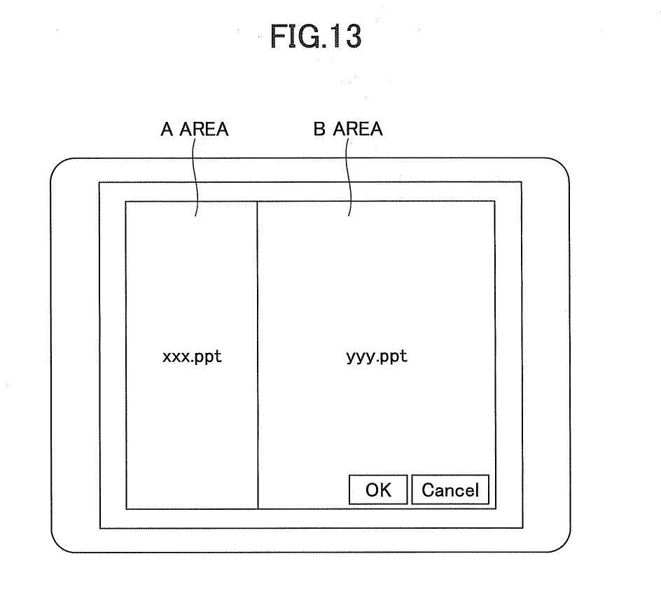

FIG. 13 is a schematic diagram illustrating the association operation (part 2) according to an embodiment of the present invention. As a result of the association operation illustrated in FIG. 12, handout data “xxx.ppt” is associated to the A area, and handout data “yyy.ppt” is associated to the B area. As a rule, handout data is associated to each area of the venue.

Step S15: When the organizer presses the “OK” button displayed on the display screen of the setting terminal 5, the division data transmission unit 53 of the setting terminal 5 transmits association data to the conference support server 1. For example, the transmitted association data may be expressed as “A area: xxx.ppt” and “B area: yyy.ppt”.
Step S16: The region division unit 14 of the conference support server associates the two divided regions (i.e. A area, B area) to corresponding handout data to be transmitted based on the association data received from the setting terminal 5. The association data are associated and stored, for example, in a manner illustrated in FIG. 9.

### (Supplementary Explanation)

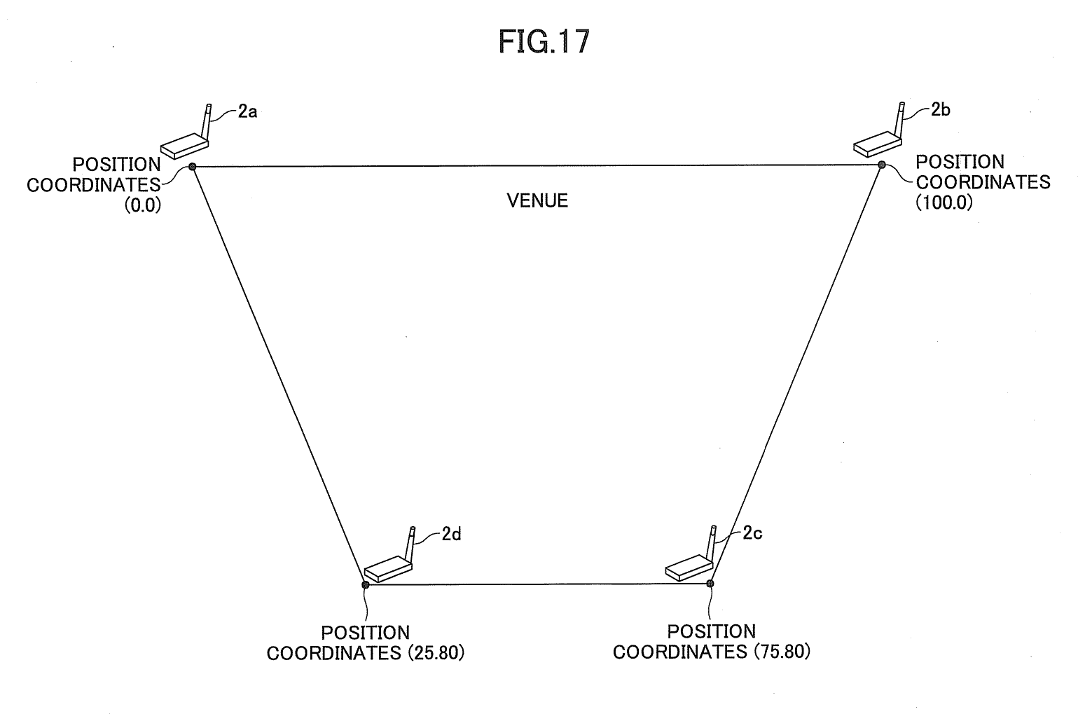

As described above in Steps S2 and S3, the entire region determination unit 13 of the conference support server 1 determines the entire region of the venue based on the position data of the position data transmission apparatuses, and the storage unit 11 stores the determined entire region as the entire region data 11a (see, for example, FIGS. 5 and 17).

Therefore, in an alternative case where a conference or the like is held at the same venue at another time (e.g., next conference), the entire region data 11a stored in past can be reused by assigning a file name or the like to the entire region data 11a and storing the entire region data 11a together with the assigned file name or the like. In the case where the conference or the like is held at the same venue, the Steps S1-S3 can be omitted. Therefore, the organizer does not need to place the position data transmission apparatus 2 in the venue and begin the region division step from the setting start operation of Step S4.

For example, in a case of setting the entire region of the venue according to the alternative case, the organizer accesses the entire region data 11a stored in the conference support server 1, and selects one entire region data 11a from a list of file names of entire region data 11a stored in the storage unit 11 by using the setting terminal 5 (Step S4). When the entire region of the venue is selected by the organizer, the display unit 51 of the setting terminal 5 transmits a request for obtaining data such as data pertaining to the selected entire region of the venue (e.g., entire region data 11a, handout data) to the conference support server 1 (Step S5). In response to the request transmitted from the setting terminal 5, the entire region determination unit 13 transmits the requested data pertaining to the selected entire region (e.g., entire region data 11a, handout data) to the setting terminal 5 (Step S6).

Further, the entire region data 11a may be mapped with a separate layout (blueprint) of the venue, and stored together with the layout or blueprint. Accordingly, a diagram equivalent to the layout (blueprint) of the venue can be displayed on the display screen of the setting terminal 5 (Step S7). That is, the display unit 51 can display the entire region in a superposed relation with the layout. For example, by having the stage (podium), the seat arrangement, or the aisles of the venue illustrated in the layout or blueprint displayed on the display screen of the setting terminal 5, the organizer can input division data that accurately matches the actual layout of the venue in a case of dividing the entire region of the venue into plural divisional regions. This further facilitates the operability of the setting terminal 5 for the organizer.

### (Handout Data Distribution Step)

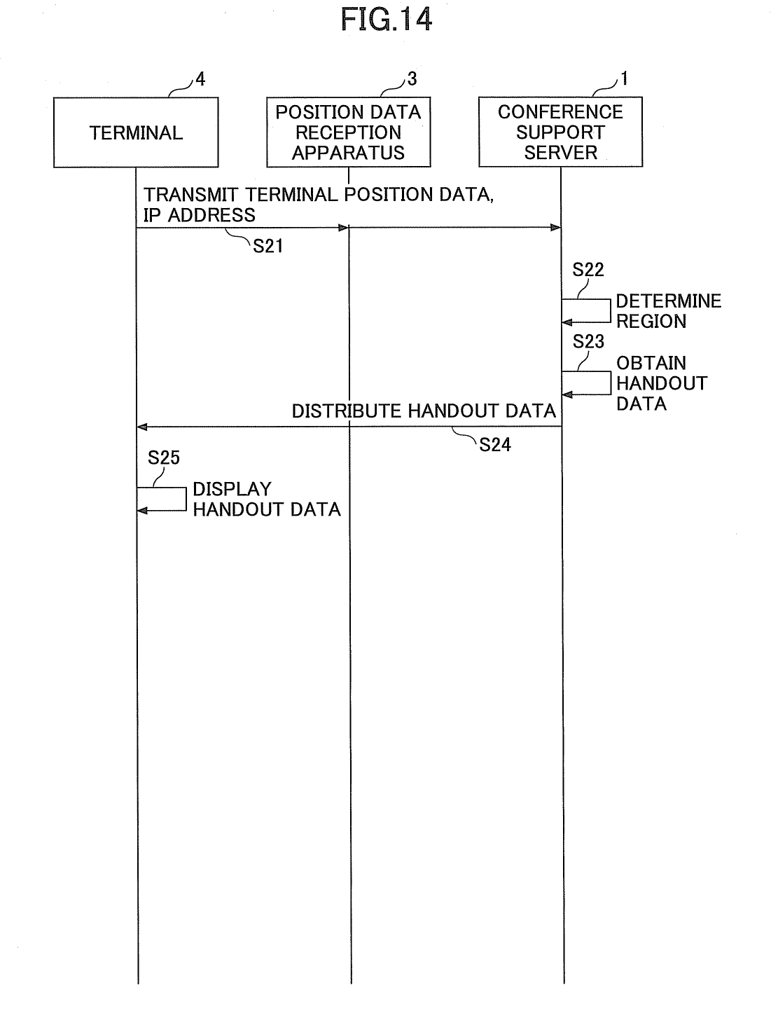

FIG. 14 is a sequence diagram for describing the handout data distribution step according to an embodiment of the present invention. The handout data distribution step is performed after the participants of the conference are seated at the venue.

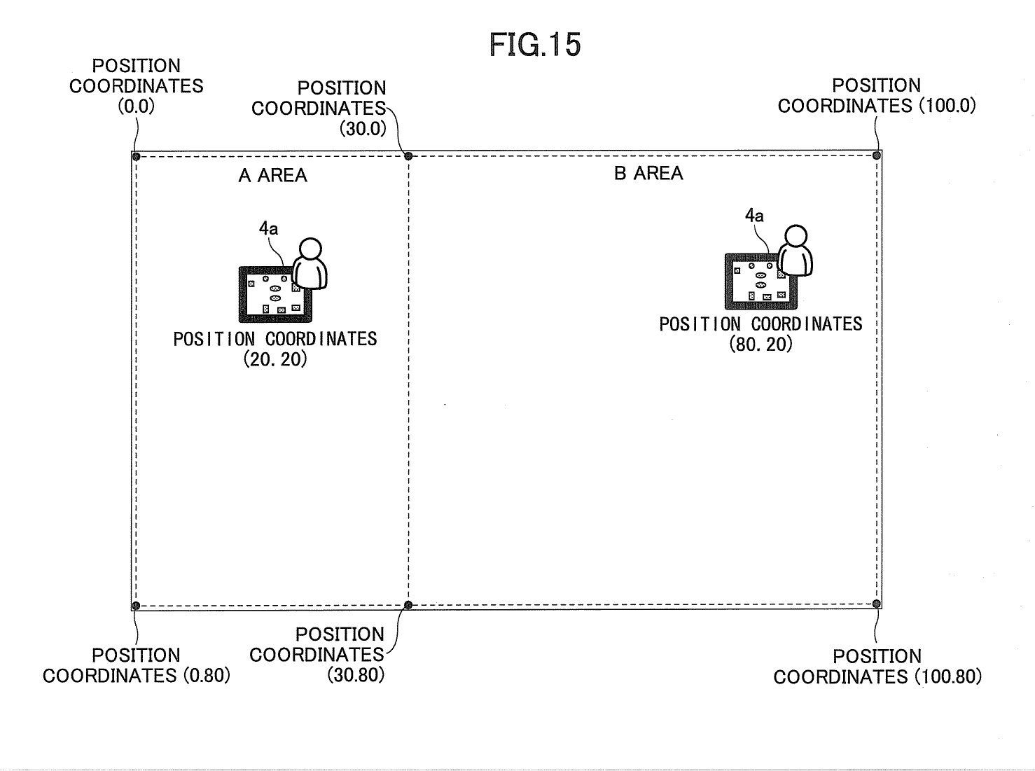

FIG. 15 is a schematic diagram illustrating an example of the positions of the seats of the participants of the conference according to an embodiment of the present invention. In the example illustrated in FIG. 15, the seats for the guests such as guests of honor and the seats for regular participants are clearly distinguished by, for example, signs or direction boards set at the venue. Accordingly, the guests bringing their display terminals 4a are seated at guest seats (e.g., A area) of the venue whereas the regular participants bringing their display terminals 4b are seated at regular seats (e.g., B area) of the venue.

Step S21: The participants activate their display terminals 4 (4a, 4b) after the participants are seated. Then, the participants complete wireless connection settings by, for example, obtaining an IP address by using DHCP (Dynamic Host Configuration Protocol). Then, when the participants performs a predetermined operation on their display terminals 4, the position data transmission unit 41 of the display terminals 4 transmits the position data of the display terminal 4 itself and the IP address of the display terminal 4 itself (destined for the conference support server 1) to the position data reception apparatus 3. The position data reception apparatus 3 transfers the data including the terminal position data received from the display terminals 4 to the conference support server 1. In this example, the display terminal 4a transmits terminal position data (north latitude x0.2. east longitude 0.2), and the display terminal 4b transmits terminal position data (north latitude x0.8. east longitude y0.2).
Step S22: The region determination unit 15 of the conference support server 1 determines the divisional region (among the plural divisional regions of the entire region of the venue) to which each of the display terminals 4 belongs based on the terminal position data received from the display terminals 4. In this example, the region determination unit 15 converts the terminal position data (north latitude x0.2. east longitude y0.2) received from the display terminal 4a into virtual terminal position coordinates (20.20) and converts the terminal position data (north latitude x0.3. east longitude y0.5) received from the display terminal 4b into virtual terminal position coordinates (80.20). Then, the region determination unit 15 determines the divisional region (i.e. A area or B area) to which the display terminals 4a, 4b belong based on the converted virtual terminal position coordinates. In this example, the display terminal 4a is located in the A area because the terminal position coordinates of the display terminal 4a is (20.20) and the position coordinates of the A area ranges from (0.0) to (30.80). In other words, the region determination unit 15 determines that the display terminal 4a belongs to the A area. In a similar manner, the region determination unit 15 determines that the display terminal 4b belongs to the B area.
Step S23: The handout distribution unit 16 of the conference support server 1 refers to the association relationship between the divisional regions and the presentation handout data 11c stored in the storage unit 11 (see, for example, FIG. 9) and obtains the handout data 11c associated to the divisional region to which the display terminal 2 belongs. In this example, the handout distribution unit 16 obtains a data file “xxx.ppt” associated to the A area because the display terminal 4a is determined to belong to the A area. In a similar manner, the handout distribution unit 16 obtains a data file “yyy.ppt” associated to the B area because the display terminal 4b is determined to belong to the B area.
Step S24: The handout distribution unit 16 distributes handout data to the display terminals 4. More specifically, in this example, the handout distribution unit 16 distributes the data file “xxx.ppt” to the display terminal 4a and distributes the data file “yyy.ppt” to the display terminal 4b.
Step S25: The display unit 42 of the display terminal 4 displays the received handout data. Because the data file “xxx.ppt” is distributed to the display terminal 4a, the guest participates in the conference by browsing the data file “xxx.ppt” dedicated for the guest with the display terminal 4a. The regular participants participates in the conference by browsing the data file “yyy.ppt” dedicated for the regular participant with the display terminal 4b.

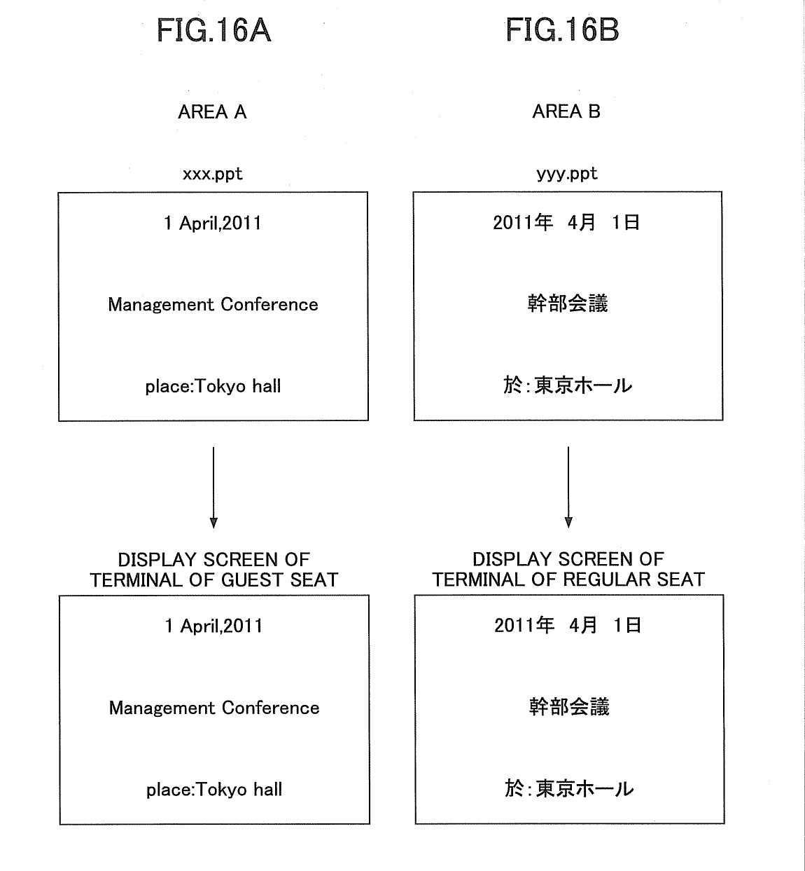

FIGS. 16A and 16B are schematic diagrams illustrating examples of display screens of the display terminals 4a and 4b according to an embodiment of the present invention. As illustrated in FIGS. 16A and 16B, the data file “xxx.ppt” of an English version handout is transmitted to and displayed on the display terminal 4a at the guest seat in the A area and the data file “yyy.ppt” of a Japanese version handout is transmitted to and displayed on the display terminal 4b at the regular seat in the B area.

With the conference support system 100 according to the above-described embodiment of the present invention, the organizer of a conference or the like can operate on the setting terminal 5 to divide the entire region of the venue into plural divisional regions (areas) in correspondence with the locations in which the participants of a presentation of the conference are to be seated. Further, the organizer 5 can operate on the setting terminal 5 to determine which presentation handout is to be distributed to the display terminals 4 of the participants in each of the divisional areas. Further, once the participants are seated, the conference support system 100 can obtain terminal position data from the display terminals 4 of the participants, confirm the areas in which the participants are seated, and determine the presentation handouts to be distributed. Hence, with the conference support system 100 according to the above-described embodiment of the present invention, the process of registering the participants of the conference beforehand or the process of setting the association relationship of handouts can be omitted. Therefore, even in a case where there is an unexpected person participates in the conference and is seated, a presentation handout suitable for the unexpected person can be distributed to the unexpected person.

### Modified Example 1

Next, a modified example of the entire region of the venue is described.

FIG. 17 is an example of determining the entire region data according to modified example 1. As described above, the entire region data 11 indicates the entire region of the venue and is determined by the entire region determination unit 13 based on the position data of the position data transmission apparatus 2.

In the example illustrated in FIG. 4, at least two position data transmission apparatuses 2 are to be placed for determining the entire region of the venue because the venue has a rectangular shape. However, more position data transmission apparatuses 2 may be required to be placed depending on the shape of the venue.

For example, the venue illustrated in FIG. 17 has a trapezoidal shape. Therefore, four position data transmission apparatuses 2 are placed for determining the entire region of the venue. Accordingly, the four position data transmission apparatuses 2 obtain the position data of the position data transmission apparatus 2 itself, respectively. Then, the four position data transmission apparatuses 2 transmit the position data to the conference support server 1.

The conference support server 1 determines the entire region of the venue based on the position coordinates (as illustrated in FIG. 17) received from the position data transmission apparatuses 2. Because the entire region of the venue has a trapezoidal shape, the entire region of the venue can be determined by the position data obtained from at least four position data transmission apparatuses 2. More specifically, the entire region of the venue can be determined by a region formed by the position coordinates of four points which are (north latitude x0. east longitude y0), (north latitude x1. east longitude y0), (north latitude x0.75. east longitude y0.8), and (north latitude x0.25. east longitude y0.8).

It is to be noted that the coordinates of the entire region are converted into virtual position coordinates. In this example, the coordinates of the entire region are converted as follows.

(north latitude x0. east longitude y0)→(0.0)
(north latitude x1. east longitude y0)→(100.0)
(north latitude x0.75. east longitude y0.8)→(75.80)
(north latitude x0.25. east longitude y0.8)→(25.80)

The determined entire region is stored as entire region data 11a in the storage unit 11.

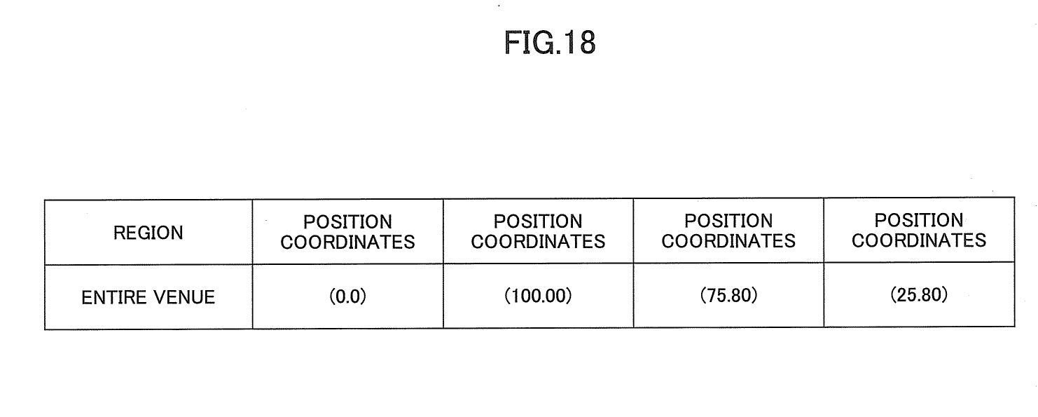

FIG. 18 is an example of the entire region data 11a according to the modified example 1. Because the venue of the modified example 1 has a trapezoidal shape, the entire region data of the entire venue is determined by storing four position coordinates.

### Modified Example 2

Next, a modified example of dividing an entire region into plural divisional regions is described. As described above, when the entire region of the venue is displayed on the display screen of the setting terminal 5, the organizer performs an operation of dividing the entire region of the venue into plural divisional regions by inputting division data, for example, by way of touching the display screen of the setting terminal 5 (see, for example, Step S8, FIG. 11). Further, after the entire region of the venue is divided, the organizer inputs data that associates the divisional regions with handout data to the setting terminal 5 by way of, for example, touching the display screen of the setting terminal 5 (see, for example, Step S14, FIGS. 12 and 13).

### Example 1

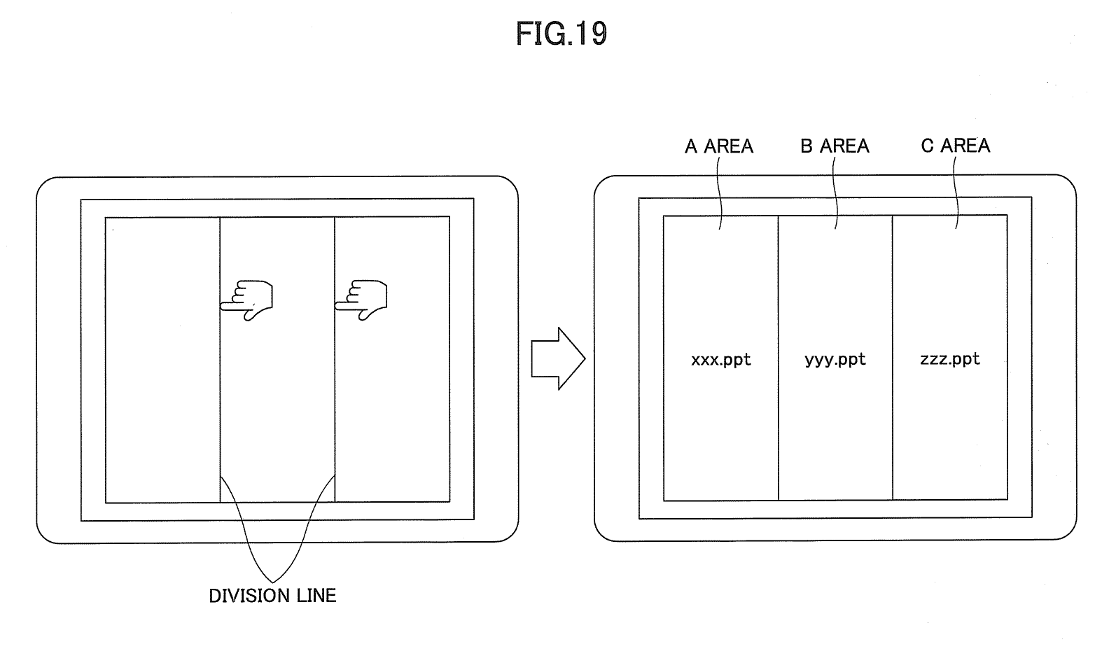

FIG. 19 is schematic diagram illustrating the modified example 2 of dividing the entire region into plural divisional regions (Part 1). In a state where the entire region of the venue is displayed on the display screen of the setting terminal 5, the organizer performs an operation of dividing the entire region of the venue into three divisional regions by inputting division data, for example, by way of touching the display screen of the setting terminal 5. In this example, the entire region is divided into an A area, a B area, and a C area as illustrated on the left side of FIG. 19.

The division data may be any form of data that expresses the two division lines input by the organizer. In this example, the division data may be expressed with virtual position coordinates (33.0), (33.80), (66.0), and (66.80).

After the entire region of the venue is divided into three divisional regions, the organizer inputs data that associates the three divisional regions with handout data to the setting terminal 5 by way of, for example, touching the display screen of the setting terminal 5. As a result of the association operation, handout data “xxx.ppt” is associated to the A area, handout data “yyy.ppt” is associated to the B area, and handout data “zzz.ppt” is associated to the C area as illustrated in the right side of FIG. 19. Alternatively, the same handout data may be associated to different areas. For example, the handout data “xxx.ppt” may be associated to the A area whereas the handout data “yyy.ppt” is associated to the B area and the C area.

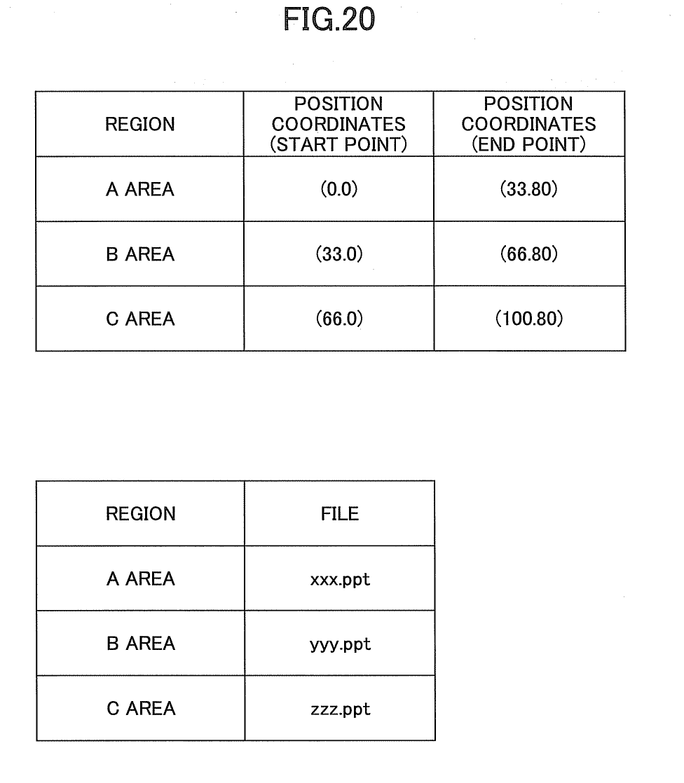

FIG. 20 is a schematic diagram illustrating an example of associating the divisional region data 11b (upper part of FIG. 20) and the presentation handout data 11c (lower part of FIG. 20) according to the modified example 2. Hence, with the above-described association operation as illustrated in FIGS. 19 and 20, the entire region can be divided into three divisional areas and corresponding handout data can be associated to the three divisional areas.

### Example 2

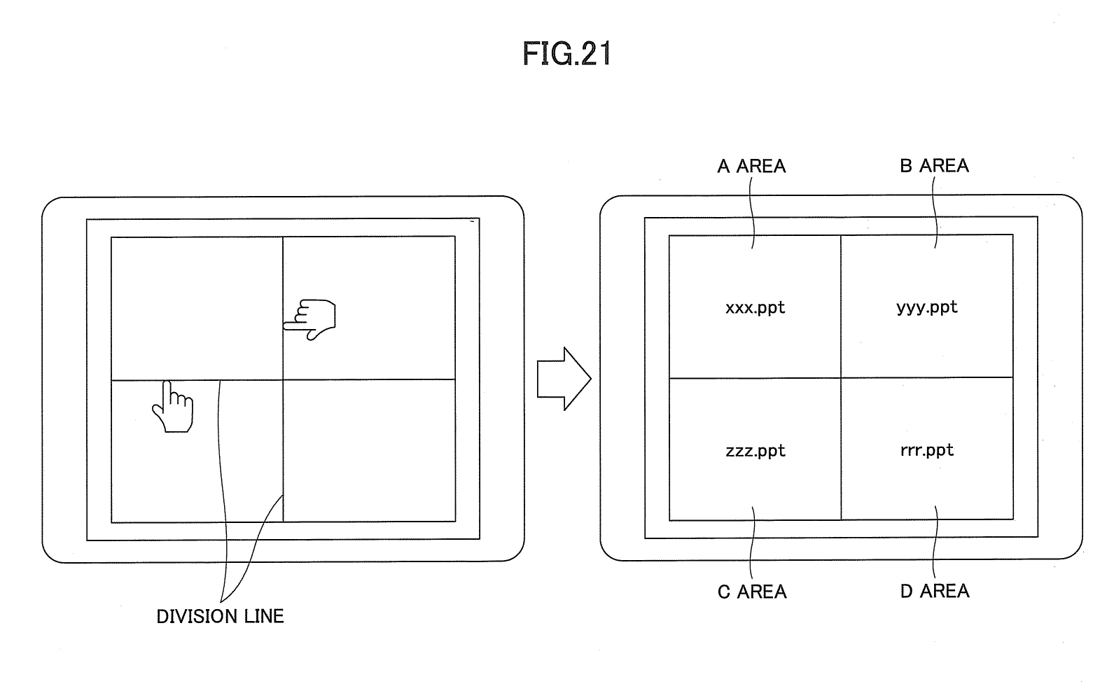

FIG. 21 is a schematic diagram illustrating the modified example 2 of dividing the entire region into plural divisional regions (Part 2). In a state where the entire region of the venue is displayed on the display screen of the setting terminal 5, the organizer performs an operation of dividing the entire region of the venue into four divisional regions by inputting division data, for example, by way of touching the display screen of the setting terminal 5. In this example, the entire region is divided into an A area, a B area, a C area, and a D area as illustrated on the left side of FIG. 21.

The division data may be any form of data that expresses the two division lines input by the organizer. In this example, the division data may be expressed with virtual position coordinates (50.0), (50.80), (0.40), and (100.40).

After the entire region of the venue is divided into four divisional regions, the organizer inputs data that associates the four divisional regions with handout data to the setting terminal 5 by way of, for example, touching the display screen of the setting terminal 5. As a result of the association operation, handout data “xxx.ppt” is associated to the A area, handout data “yyy.ppt” is associated to the B area, handout data “zzz.ppt” is associated to the C area, and handout data “rrr.ppt” is associated to the D area as illustrated in the right side of FIG. 21.

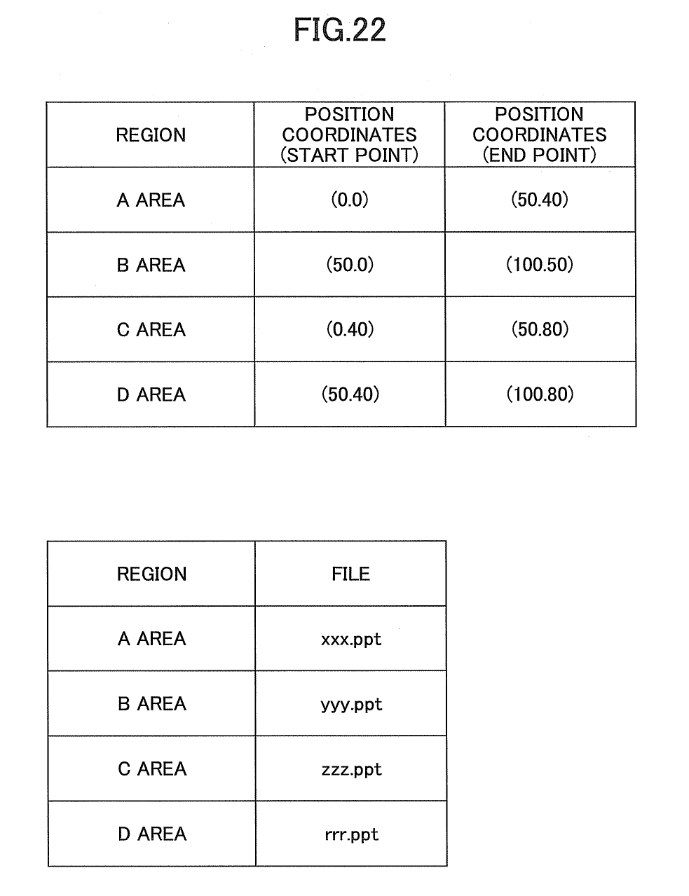

FIG. 22 is a schematic diagram illustrating an example of associating the divisional region data 11b (upper part of FIG. 22) and the presentation handout data 11c (lower part of FIG. 22) according to the modified example 2. Hence, with the above-described association operation as illustrated in FIGS. 21 and 22, the entire region can be divided into four divisional areas and corresponding handout data can be associated to the four divisional areas.

### Example 3

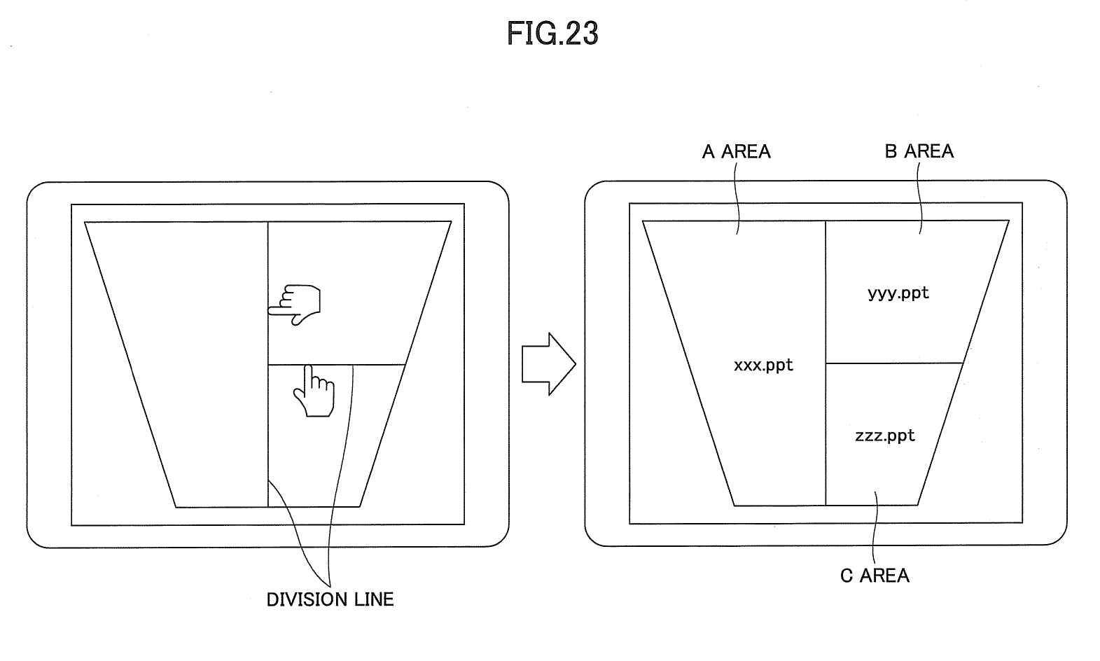

FIG. 23 is a schematic diagram illustrating the modified example 2 of dividing the entire region into plural divisional regions (Part 3). In a state where the entire region of the venue is displayed on the display screen of the setting terminal 5, the organizer performs an operation of dividing the entire region of the venue into three divisional regions by inputting division data, for example, by way of touching the display screen of the setting terminal 5. In this example, the entire region corresponds to the entire region illustrated in FIGS. 17 and 18 and is divided into an A area, a B area, and a C area as illustrated on the left side of FIG. 23.

The division data may be any form of data that expresses the two division lines input by the organizer. In this example, the division data may be expressed with virtual position coordinates (50.0), (50.80), (50.40), and (88.40).

After the entire region of the venue is divided into three divisional regions, the organizer inputs data that associates the three divisional regions with handout data to the setting terminal 5 by way of, for example, touching the display screen of the setting terminal 5. As a result of the association operation, handout data “xxx.ppt” is associated to the A area, handout data “yyy.ppt” is associated to the B area, and handout data “zzz.ppt” is associated to the C area as illustrated in the right side of FIG. 23.

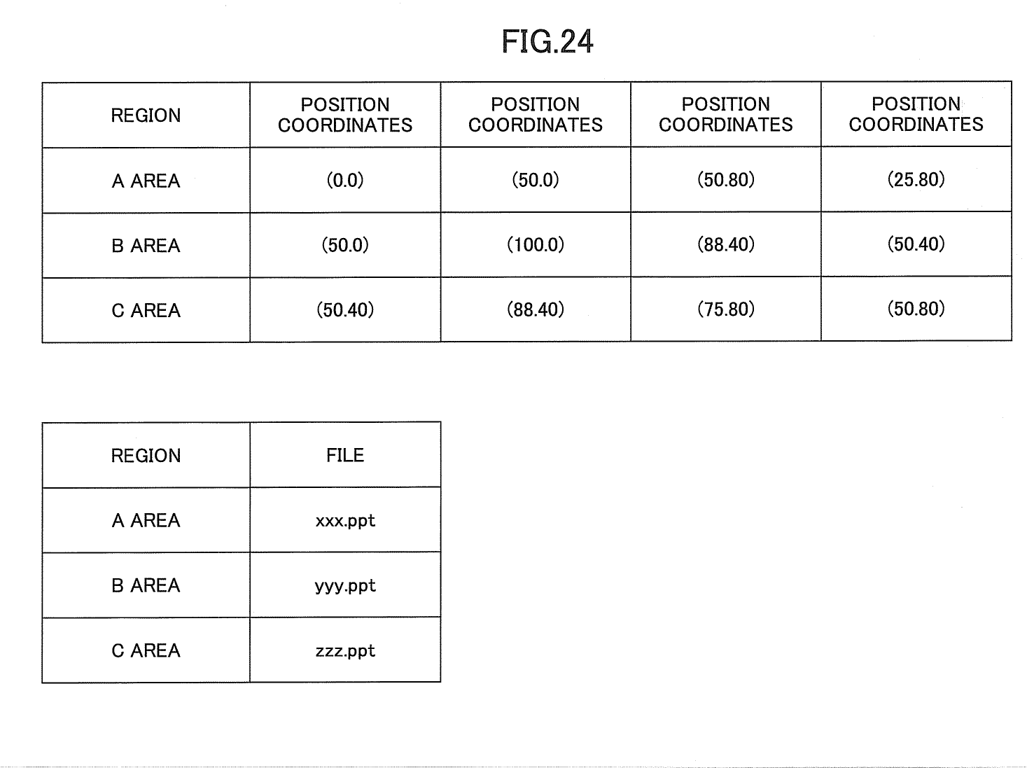

FIG. 24 is a schematic diagram illustrating an example of associating the divisional region data 11b (upper part of FIG. 24) and the presentation handout data 11c (lower part of FIG. 24) according to the modified example 2. Hence, with the above-described association operation as illustrated in FIGS. 23 and 24, the entire region can be divided into three divisional areas and corresponding handout data can be associated to the three divisional areas.

### Example 4

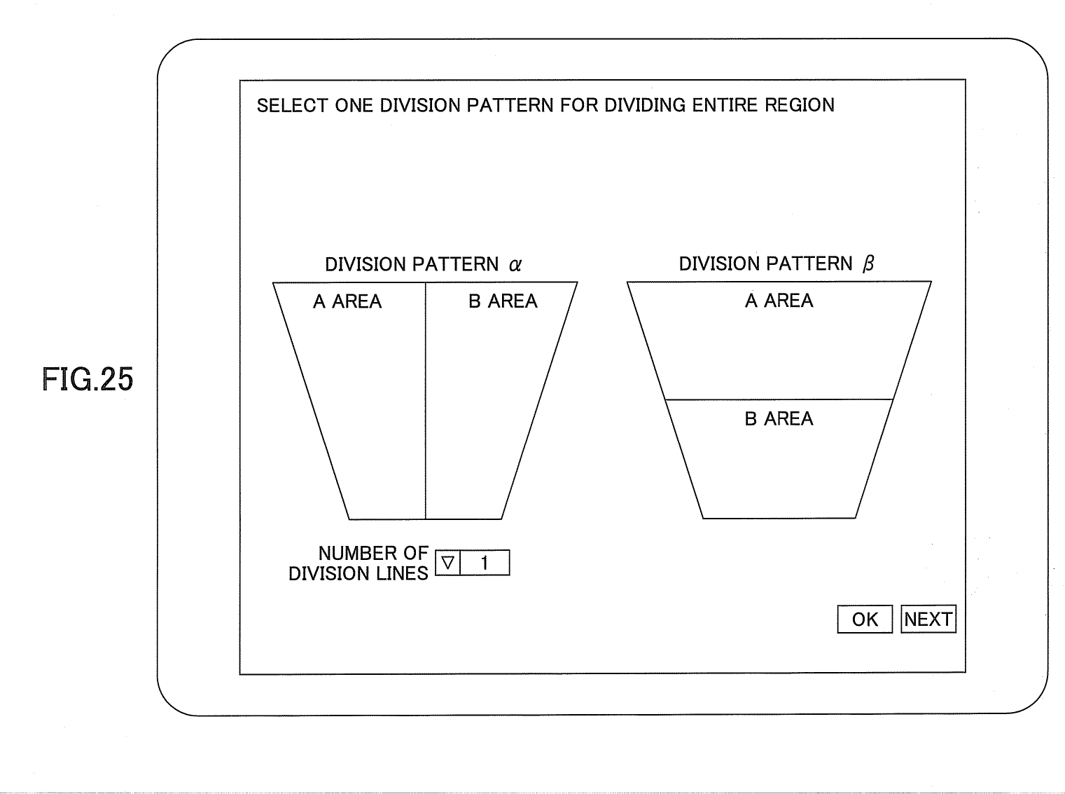

FIG. 25 is a schematic diagram illustrating the modified example 2 of dividing the entire region into plural divisional regions (Part 4). In the above-described modified examples, the organizer performs an operation of dividing the entire region of the venue into plural divisional regions by inputting division data, for example, by way of touching the display screen of the setting terminal 5. However, in this modified example, various division patterns, which illustrate the entire region of the venue being divided into various divisional regions, are provided beforehand. Accordingly, the organizer can divide the entire region of the venue by selecting one division pattern from the various division patterns provided beforehand.

When one of the division patterns is selected, division data based on a divisional line(s) of the selected division pattern is transmitted to the conference support server 1. After the entire region of the venue is divided into plural divisional regions, the organizer inputs data that associates the divisional regions with handout data to the setting terminal 5 by way of, for example, touching the display screen of the setting terminal 5.

Hence, with the above-described modified examples, the organizer can divided the entire region of the venue in accordance with, for example, the number of divisional regions, the size of the entire/divisional regions, and shapes of the entire/divisional regions. Particularly, in a case where the setting terminal 5 is a tablet-type terminal, the organizer can arbitrarily divide the entire region of the venue by performing touch operations on the setting terminal 5. Thereby, the organizer can divide the entire region of the venue into specific divisional regions.

### [General Overview]

Hence, with the conference support system, a conference support apparatus, and a handout distribution method according to the above-described embodiments of the present invention, the process of registering the participants of a conference beforehand or the process of setting the association relationship of handouts can be omitted. Therefore, even in a case where an unexpected person participates in the conference, a handout suitable for the unexpected person can be distributed to the unexpected person.

The present invention is not limited to the specifically disclosed embodiments, and variations and modifications may be made without departing from the scope of the present invention. For example, the above-described embodiments of the present invention may be implemented in any convenient form, for example, using dedicated methods, hardware, software, and computer-readable recording media, or a mixture of dedicated methods, hardware, software, and computer-readable recording media.

The present application is based on and claims the benefit of priority of Japanese Priority Application No. 2012-100289 filed on Apr. 25, 2012, the entire contents of which are hereby incorporated by reference.

What is claimed is:

1. A conference support system comprising:
first and second terminals;
a position data transmission apparatus including a transmission unit that transmits position data of the position data transmission apparatus;
a conference support apparatus including
a first reception unit that receives the position data from the position data transmission apparatus,
an entire region determination unit that determines an entire region based on the position data,
a transmission unit that transmits data of the entire region to the first terminal,
a second reception unit that receives division data from the first terminal,
a division unit that divides the entire region into a plurality of divisional regions,
a third reception unit that receives terminal position data from the second terminal,
a region determination unit that determines a target divisional region to which the second terminal belongs from the plurality of divisional regions based on the terminal position data, and
a distribution unit that distributes handout data associated to the target divisional region to the second terminal;
wherein the first terminal includes
a first terminal reception unit that receives the data of the entire region from the conference support apparatus,
a first input unit that inputs the division data, and
a first terminal transmission unit that transmits the division data input from the first input unit to the conference support apparatus,
wherein the second terminal includes a second terminal transmission unit that transmits the terminal position data to the conference support apparatus.

2. The conference support system as claimed in claim 1,
wherein the first terminal further includes a display unit that displays the entire region,
wherein when a divisional line dividing the entire region displayed on display unit is input, the first input unit inputs the division data to the first terminal transmission unit based on the divisional line.

3. The conference support system as claimed in claim 2,
wherein the conference support apparatus further includes a storage unit that stores a layout of the entire region,
wherein the transmission unit transmits the data of the entire region together with data of the layout,
wherein the display unit displays the entire region in a superposed relation with the layout.

4. The conference support system as claimed in claim 1,
wherein the conference support apparatus further includes a storage unit that stores at least two handout data,
wherein the transmission unit is configured to transmits data of the plurality of divisional regions and the at least two handout data to the first terminal,
wherein the first terminal further includes
a second terminal reception unit that receives the data of the plurality of divisional regions and the at least two handout data,
a second input unit that inputs association data indicating the data of the plurality of divisional regions associated to the at least two handout data, and
a second terminal transmission unit that transmits the association data to the conference support apparatus.

5. The conference support system as claimed in claim 4,
wherein the first terminal further includes a display unit that displays the data of the plurality of divisional regions and the at least two handout data,
wherein when one of the data of the plurality of divisional regions is selected together with an associated one of the at least two handout data, the second input unit is configured to input the association data including the selected one of the data of the plurality of divisional regions and the associated one of the at least two handout data.

6. The conference support system as claimed in claim 1, wherein the first terminal, the second terminal, the position data transmission terminal, and the conference support apparatus are connected to each other by a network.

7. A conference support apparatus comprising:
a first reception unit that receives position data from a position data transmission apparatus;
an entire region determination unit that determines an entire region based on the position data;
a transmission unit that transmits data of the entire region to a first terminal;
a second reception unit that receives division data from the first terminal;
a division unit that divides the entire region into a plurality of divisional regions;
a third reception unit that receives terminal position data from a second terminal;
a region determination unit that determines a target divisional region to which the second terminal belongs from the plurality of divisional regions based on the terminal position data; and
a distribution unit that distributes handout data associated to the target divisional region to the second terminal.

8. The conference support apparatus as claimed in claim 7,
wherein the first terminal further includes
a first input unit that inputs the division data,
a first terminal transmission unit that transmits the division data,
a display unit that displays the entire region,
wherein when a divisional line dividing the entire region displayed on the display unit is input, the first input unit inputs the division data to the first terminal transmission unit based on the divisional line,
wherein the second reception unit is configured to receive the division data transmitted from the first terminal transmission unit.

9. The conference support apparatus as claimed in claim 8, further comprising: a storage unit that stores a layout of the entire region,
wherein the transmission unit transmits the data of the entire region together with data of the layout,
wherein the display unit displays the entire region in a superposed relation with the layout.

10. The conference support apparatus as claimed in claim 7, further comprising: a storage unit that stores at least two handout data,
wherein the transmission unit is configured to transmits data of the plurality of divisional regions and the at least two handout data to the first terminal,
wherein the first terminal further includes
a second terminal reception unit that receives the data of the plurality of divisional regions and the at least two handout data,
a second input unit that inputs association data indicating the data of the plurality of divisional regions associated to the at least two handout data, and
a second terminal transmission unit that transmits the association data to the conference support apparatus.

11. The conference support apparatus as claimed in claim 10,
wherein the first terminal further includes a display unit that displays the data of the plurality of divisional regions and the at least two handout data,
wherein when one of the data of the plurality of divisional regions is selected together with an associated one of the at least two handout data, the second input unit is configured to input the association data including the selected one of the data of the plurality of divisional regions and the associated one of the at least two handout data,
wherein the distribution unit is configured to distribute the handout data based on the association data transmitted from the second terminal transmission unit.

12. The conference support apparatus as claimed in claim 7, wherein the first terminal, the second terminal, the position data transmission terminal, and the conference support apparatus are connected to each other by a network.

13. A handout distribution method for causing a conference support apparatus to perform a handout distribution process, the handout distribution method comprising:
a first receiving step of receiving position data from a position data transmission apparatus;
an entire region determining step of determining an entire region based on the position data;
a transmitting step of transmitting data of the entire region to a first terminal;
a second receiving step of receiving division data from the first terminal;
a dividing step of dividing the entire region into a plurality of divisional regions;
a third receiving step of receiving terminal position data from a second terminal;
a region determining step of determining a target divisional region to which the second terminal belongs from the plurality of divisional regions based on the terminal position data; and
a distributing step of distributing handout data associated to the target divisional region to the second terminal.

14. The handout distribution method as claimed in claim 13,
wherein the first terminal includes
a first input unit that inputs the division data,
a first terminal transmission unit that transmits the division data,
a display unit that displays the entire region,
wherein when a divisional line dividing the entire region displayed on the display unit is input, the first input unit inputs the division data to the first terminal transmission unit based on the divisional line,
wherein the second receiving step includes receiving the division data transmitted from the first terminal transmission unit.

15. The handout distribution method as claimed in claim 14, further comprising a storing step of storing a layout of the entire region,
wherein the transmission unit transmits the data of the entire region together with data of the layout,
wherein the display unit displays the entire region in a superposed relation with the layout.

16. The handout distribution method as claimed in claim 13, further comprising a storing step of storing at least two handout data,
wherein the transmission unit is configured to transmits data of the plurality of divisional regions and the at least two handout data to the first terminal,
wherein the first terminal includes
a second terminal reception unit that receives the data of the plurality of divisional regions and the at least two handout data,
a second input unit that inputs association data indicating the data of the plurality of divisional regions associated to the at least two handout data, and
a second terminal transmission unit that transmits the association data to the conference support apparatus.

17. The handout distribution method as claimed in claim 16,
wherein the first terminal further includes a display unit that displays the data of the plurality of divisional regions and the at least two handout data,
wherein when one of the data of the plurality of divisional regions is selected together with an associated one of the at least two handout data, the second input unit is configured to input the association data including the selected one of the data of the plurality of divisional regions and the associated one of the at least two handout data,
wherein the distributing step includes distributing the handout data based on the association data transmitted from the second terminal transmission unit.

18. The handout distribution method as claimed in claim 13, wherein the first terminal, the second terminal, the position data transmission terminal, and the conference support apparatus are connected to each other by a network.
